(19) United States
(12) Patent Application Publication
(10) Pub. No.: US 2022/0253954 A1
(43) Pub. Date: Aug. 11, 2022

(54) POST-PROCESSING HEURISTICS FOR OPTIMAL PRODUCTION SCHEDULING FOR PROCESS MANUFACTURING

(71) Applicant: C3.ai, Inc., Redwood City, CA (US)

(72) Inventors: Christian S. Brown, San Francisco, CA (US); Sina K. Pakazad, Redwood City, CA (US); Zhaoxi Zhang, Palo Alto, CA (US); Timothy P. Holtan, Naperville, IL (US)

(21) Appl. No.: 17/665,435

(22) Filed: Feb. 4, 2022

Related U.S. Application Data
(60) Provisional application No. 63/145,949, filed on Feb. 4, 2021.

(51) Int. Cl. G06Q 50/04; G06Q 10/06

(52) U.S. Cl. CPC G06Q 50/04; G06Q 10/06312

(57) ABSTRACT

A method includes obtaining a solution representing a proposed production schedule associated with multiple processing units in a facility, where the multiple processing units are capable of producing different products. The method also includes performing post-processing of the solution to identify a final production schedule for the processing units in the facility. The post-processing of the solution includes multiple operations each configured to modify the proposed production schedule so that the final production schedule is feasible given constraints associated with the processing units in the facility.

### CROSS-REFERENCE TO RELATED APPLICATION AND PRIORITY CLAIM

This application claims priority under 35 U.S.C. § 119(e) to U.S. Provisional Patent Application No. 63/145,949 filed on Feb. 4, 2021. This provisional application is hereby incorporated by reference in its entirety.

### TECHNICAL FIELD

This disclosure is generally directed to production planning and scheduling systems. More specifically, this disclosure is directed to post-processing heuristics for optimal production scheduling for process manufacturing.

### BACKGROUND

Production scheduling generally refers to the process of determining how process units in a process manufacturing plant will be used to produce one or more products. The process units generally represent equipment that can be used to perform specific processing functions on one or more materials. For example, production scheduling may involve determining how equipment in a chemical manufacturing plant will be used to produce polymers, such as polypropylene or polyethylene, or other chemical products. Production scheduling for a plant typically involves dictating the production schedule (such as one or more products to be produced, quantities of the one or more products to be produced, and timing of the one or more products to be produced) for the processing units contained in the plant over a forward-looking scheduling horizon.

### SUMMARY

This disclosure relates to post-processing heuristics for optimal production scheduling for process manufacturing.

In a first embodiment, a method includes obtaining a solution representing a proposed production schedule associated with multiple processing units in a facility, where the multiple processing units are capable of producing different products. The method also includes performing post-processing of the solution to identify a final production schedule for the processing units in the facility. The post-processing of the solution includes multiple operations each configured to modify the proposed production schedule so that the final production schedule is feasible given constraints associated with the processing units in the facility.

In a second embodiment, an apparatus includes at least one processing device configured to obtain a solution representing a proposed production schedule associated with multiple processing units in a facility, where the multiple processing units are capable of producing different products. The at least one processing device is also configured to perform post-processing of the solution to identify a final production schedule for the processing units in the facility. The post-processing of the solution includes multiple operations each configured to modify the proposed production schedule so that the final production schedule is feasible given constraints associated with the processing units in the facility.

In a third embodiment, a non-transitory computer readable medium stores computer readable program code that when executed causes one or more processors to obtain a solution representing a proposed production schedule associated with multiple processing units in a facility, where the multiple processing units are capable of producing different products. The medium also stores computer readable program code that when executed causes the one or more processors to perform post-processing of the solution to identify a final production schedule for the processing units in the facility. The post-processing of the solution includes multiple operations each configured to modify the proposed production schedule so that the final production schedule is feasible given constraints associated with the processing units in the facility.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting constrained optimization and post-processing heuristics for optimal production scheduling for process manufacturing according to this disclosure;

FIG. 2 illustrates an example device supporting constrained optimization and post-processing heuristics for optimal production scheduling for process manufacturing according to this disclosure;

FIGS. 3A and 3B illustrate example graph representations of equipment and equipment interactions in a facility according to this disclosure;

FIG. 4 illustrates example insertion and removal operations involving a data structure representing batches of materials in a production schedule according to this disclosure;

FIGS. 5 and 6 illustrate example results obtained using a chunk and merge process to combine batches of common materials in a production schedule according to this disclosure;

FIG. 7 illustrates example search results obtained using a resequence process to change the order of batches of materials in a production schedule according to this disclosure;

FIG. 8 illustrates example results obtained using a resequence process to change the order of batches of materials in a production schedule according to this disclosure;

FIG. 9 illustrates example results obtained using a round to production unit process to change the quantities of materials in a production schedule according to this disclosure;

FIG. 10 illustrates example results obtained using an inject time gap process to insert time periods between production of materials in a production schedule according to this disclosure;

FIGS. 11 and 12 illustrate example results obtained using an align auxiliary nodes to parent nodes process to align production by different nodes according to this disclosure;

FIGS. 13 and 14 illustrate example results obtained using a shift and merge process to combine production of common materials in a production schedule according to this disclosure; and

FIG. 15 illustrates an example method for constrained optimization and post-processing heuristics for optimal production scheduling for process manufacturing according to this disclosure.

### DETAILED DESCRIPTION

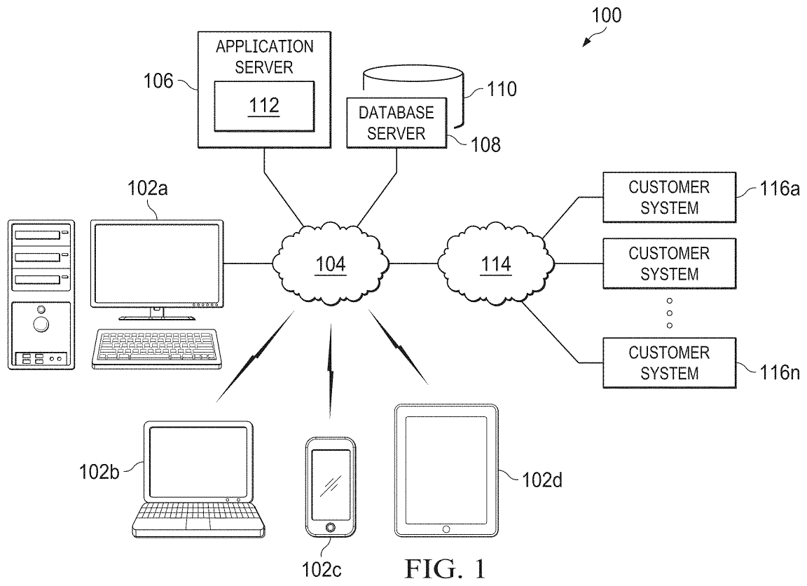

FIGS. 1 through 15, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, production scheduling generally refers to the process of determining how process units in a process manufacturing plant will be used to produce one or more products. The process units generally represent equipment that can be used to perform specific processing functions on one or more materials. For example, production scheduling may involve determining how equipment in a chemical manufacturing plant will be used to produce polymers, such as polypropylene or polyethylene, or other chemical products. Production scheduling for a plant typically involves dictating the production schedule (such as one or more products to be produced, quantities of the one or more products to be produced, and timing of the one or more products to be produced) for the processing units contained in the plant over a forward-looking scheduling horizon. An optimal production schedule for a plant is a schedule that satisfies some specified criterion or criteria, such as maximizing revenue, minimizing costs, minimizing energy usage, or minimizing raw material usage. Also, for a production schedule to be valid, the production schedule needs to honor the operational constraints of the plant itself, such as mass-balances, energy balances, and transition dynamics.

Production scheduling has traditionally been performed manually at the discretion of plant operators. Unfortunately, production scheduling is typically labor-intensive and commonly fails to make optimal use of the full capacity of a plant. Also, production scheduling algorithms are often only able to solve a production scheduling problem approximately and are not able to correctly model the dynamics of a plant. Production scheduling algorithms also typically ignore many constraints, including entire unit operations and logistical constraints, because the plant is not modeled correctly. This can lead to the generation of infeasible schedules that then need to be corrected manually by the plant operators.

This disclosure provides an apparatus, method, and computer readable medium supporting a process that produces a more optimal production schedule for process unit operations in one or more process manufacturing plants. The overall process includes two general operations, which may in some instances be implemented as separate modules (although this need not be the case). A first general operation involves constrained optimization of an optimization problem. The optimization problem includes constraints that describe processes governing the processing units, constraints that describe interactions among the processing units, and constraints that allow efficient formulation of objectives. Using an objective function, such as cost minimization or profit maximization, costs associated with production transitions, inventory holding costs, serviceability costs, and other costs that define the economic gains or process costs associated with the plant can be encoded. During constrained optimization, an approximate optimal solution for the full optimization problem is obtained by solving a relaxed formulation of the full optimization problem. For example, one or more relaxed versions of the optimization problem can be formulated and solved, such as by using an optimization solver. A second general operation involves post-processing heuristics. Here, the relaxed solution produced by the first operation is post-processed (modified) to yield a feasible solution for the full optimization problem. This can be done iteratively while monitoring the costs associated with a generated schedule for all processing units in the plant and ensuring convergence to one or more suitable solutions to the full production scheduling optimization problem.

In this way, the described approaches can be performed much more quickly and with much less manual effort by plant operators or other personnel. Moreover, the described approaches are typically able to make improved or optimal use of the full capacity of a plant compared to manual approaches. In addition, the described approaches are able to more effectively model the dynamics of a plant and consider many constraints like entire unit operations and logistical constraints. This makes production schedules generated using the described approaches much more likely to be implementable by a plant (with or without subsequent manual adjustments by plant operators).

Note that the approaches described below for optimal production scheduling using constrained optimization and post-processing heuristics may be used in any number of applications. Example use cases for the described approaches may include use with chemical manufacturing or processing facilities, food processing facilities, paper or pulp manufacturing or processing facilities, and oil and gas processing facilities. In general, the approaches described below may be used in any suitable manner to support optimal production scheduling using constrained optimization and post-processing heuristics.

Also note that while the approaches described below for optimal production scheduling use both constrained optimization and post-processing heuristics, it is possible for production scheduling to occur using one of constrained optimization or post-processing heuristics (but not both). For example, the constrained optimization may be used to generate one or more solutions representing one or more production schedules, and the one or more solutions may be used in any suitable manner with or without post-processing heuristics. Also, the post-processing heuristics may be used with any suitable solution generated with or without constrained optimization.

FIG. 1 illustrates an example system 100 supporting constrained optimization and post-processing heuristics for optimal production scheduling for process manufacturing according to this disclosure. For example, the system 100 shown here can be used to support the production scheduling process described below. As shown in FIG. 1, the system 100 includes user devices 102a-102d, one or more networks 104, one or more application servers 106, and one or more database servers 108 associated with one or more databases 110. Each user device 102a-102d communicates over the network 104, such as via a wired or wireless connection. Each user device 102a-102d represents any suitable device or system used by at least one user to provide or receive information, such as a desktop computer, a laptop computer, a smartphone, and a tablet computer. However, any other or additional types of user devices may be used in the system 100.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. In some cases, the network 104 may represent an internal or private network used by an owner or operator of a process manufacturing plant.

The application server 106 is coupled to the network 104 and is coupled to or otherwise communicates with the database server 108. The application server 106 supports the production scheduling process described below. For example, the application server 106 may execute one or more applications 112 that use data from the database 110 to perform production scheduling. Note that the database server 108 may also be used within the application server 106 to store information, in which case the application server 106 may store the information itself used to perform production scheduling.

The database server 108 operates to store and facilitate retrieval of various information used, generated, or collected by the application server 106 and the user devices 102a-102d in the database 110. For example, the database server 108 may store various information related to customer product orders and other information used during production scheduling.

In this example, at least some of the information used by the application server 106 and/or stored in the database 110 may be received over at least one additional network 114 from one or more customer systems 116a-116n. For example, the network 114 may represent a public data network (such as the Internet) or other network that allows the one or more customer systems 116a-116n to provide information to and receive information from the owner or operator of a process manufacturing plant. As a particular example, the one or more customer systems 116a-116n may be used by customers to provide order information to the owner or operator of the process manufacturing plant, where that information can be used by the application server 106 to perform production scheduling.

A determined production schedule produced by the application server 106 may be used in any suitable manner. For example, the determined production schedule may be presented to one or more users, such as via one or more of the user devices 102a-102d. The one or more users may review the determined production schedule, make changes to the determined production schedule, or perform other actions using the determined production schedule. The determined production schedule may also be used by the application server 106 or other device to automatically schedule operations to be performed to produce one or more products or control operations being performed to produce one or more products. In general, one or more production schedules may be used in any suitable manner with or without user interaction.

Although FIG. 1 illustrates one example of a system 100 supporting constrained optimization and post-processing heuristics for optimal production scheduling for process manufacturing, various changes may be made to FIG. 1. For example, the system 100 may include any number of user devices 102a-102d, networks 104, 114, application servers 106, database servers 108, databases 110, and customer systems 116a-116n. Also, these components may be located in any suitable locations and might be distributed over a large area. In addition, while FIG. 1 illustrates one example operational environment in which production scheduling may be used, this functionality may be used in any other suitable system.

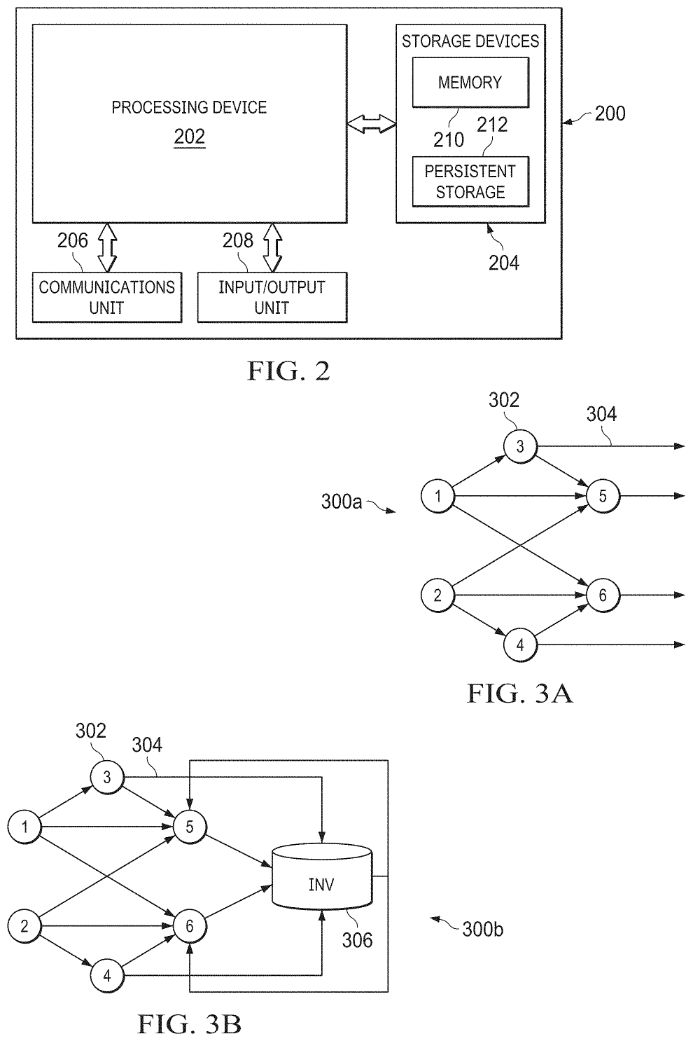

FIG. 2 illustrates an example device 200 supporting constrained optimization and post-processing heuristics for optimal production scheduling for process manufacturing according to this disclosure. One or more instances of the device 200 may, for example, be used to at least partially implement the functionality of the application server 106 of FIG. 1. However, the functionality of the application server 106 may be implemented in any other suitable manner. In some embodiments, the device 200 shown in FIG. 2 may form at least part of a user device 102a-102d, application server 106, database server 108, or customer system 116a-116n in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network, such as the network 104 or 114. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

Although FIG. 2 illustrates one example of a device 200 supporting constrained optimization and post-processing heuristics for optimal production scheduling for process manufacturing, various changes may be made to FIG. 2. For example, computing and communication devices and systems come in a wide variety of configurations, and FIG. 2 does not limit this disclosure to any particular computing or communication device or system.

The following now describes example approaches for performing constrained optimization and using post-processing heuristics for optimal production scheduling for process manufacturing. Note that the specific details provided below are for illustration only and can vary as needed or desired. For instance, specific equations are provided below for features such as an objective function, and these equations may be modified as needed or desired. For ease of explanation, it is assumed that the approaches described below are performed using the application server 106 of FIG. 1, which may be implemented using one or more instances of the device 200 of FIG. 2. However, the approaches described below may be implemented using any suitable device(s) in any suitable system(s).

FIGS. 3A and 3B illustrate example graph representations 300a-300b of equipment and equipment interactions in a facility according to this disclosure. As shown in FIG. 3A, the graph representation 300a includes a number of nodes 302 and a number of flows 304 that identify interactions between the nodes 302. Each node 302 represents one or more pieces of equipment in a processing facility that can be used to perform one or more functions on one or more materials. For example, each node 302 may represent one or more pieces of industrial equipment used to process at least one raw material or intermediate product in order to produce at least one processed material (which may represent a final product or another intermediate product). Each flow 304 represents a movement of at least one material (such as at least one raw material, intermediate product, or final product) to or from a node 302 or between nodes 302. In general, a processing facility may include various equipment represented by a large number of nodes 302, and the processing facility may support a large number of possible flows 304 depending (among other things) on the specific product(s) being produced and the specific equipment used to process materials.

Based on the graph representation 300a, consider a facility that produces a set of materials, some of which can be sold or otherwise provided to customers as final products. An ordered set of indices may be used to represent the various products prod such that prod= [symbol] ₘ={1, . . . , m}, where m is the number of materials produced within the facility. Also, the set of final products sold or otherwise provided to customers can be denoted as ter⊂prod. The facility may include a set of N pieces of equipment or process steps, and the final products may be produced as a result of directed interactions among these pieces of equipment. This can be represented using a graph representation 300a having the form of a directed graph G (V, ϵ) with a vertex set V= [symbol] _{N} and an edge set ϵ. A simplified example of this is shown in FIG. 3A, where the vertex set V includes the nodes 302 and the edge set £ includes the flows 304. Note that the direction of each flow 304 encodes a possible flow of one or more materials from one node 302 to another node 302.

It may be assumed that each node 302 (denoted node i) can produce a set of materials, which can be denoted as prodⁱ⊆prod. Also, let the set of nodes 302 producing one or more final products be denoted as terminal. In FIG. 3A, terminal={3, 4, 5, 6} since the nodes 302 numbered three, four, five, and six are producing final products. The one or more materials produced by these terminal nodes 302 may flow into an inventory of final products, which can be sold or otherwise provided to customers. In some cases, it may also be assumed that some of the final products can be further processed to make other final products. An example of this is shown in FIG. 3B, where the graph representation 300b includes the nodes 302, flows 304, and at least one inventory 306. The inventory 306 represents one or more of the final products produced by one or more of the nodes 302, where at least some of the inventory 306 may be provided via one or more flows 304 to one or more nodes 302 for additional processing. The graph representation 300b shown in FIG. 3B may be defined as a directed graph G( [symbol] , ϵ̅), where [symbol] =(1, 2, 3, . . . , 6, Inv) in the example of FIG. 3B.

It can further be assumed that a material j produced by a node i can be converted into another set of one or more materials by a node k. More specifically, it can be assumed that each unit of material j produced by a node i can be converted into one or more different amounts of one or more materials produced by a node k. Based on this, the set of materials produced by the node k can be denoted as prod_{i,j}^{k}, and the material amounts produced by the node k given a unit of material t can be denoted as Uₜ^{k}. In addition, the number of time steps that it takes for transporting one or more materials from the node i to the node k can be denoted as Sᵢₖ, which may correspond to the i-k^{th} entry in a matrix S Ε [symbol] ^{(N×1)×(N×1)} (where the last row and the last column correspond to the transportation times from and to the inventory 306).

The information described above may fully describe the interactions between the nodes 302 in the facility. It is then possible to define constraints governing the function or functions of each node 302. First, assume that each node 302 at any given time can only produce one and only one material, such as one intermediate product or one final product. Second, given a maximum production rate for each material, assume that each node 302 can only produce a maximum amount of material within a given period of time. Conversely, there may also exist a minimum production rate/amount associated with each node-material combination. Third, as noted earlier, each node 302 can produce a set of materials, and there is typically a different cost associated with transitioning from producing one material to another material. A transition cost associated with transitioning from producing a material j to producing a material t at a node i can be denoted as Cⱼₜⁱ, which may correspond to the j-t^{th} entry in a matrix Cⁱ.

Given demand forecasts for final products by customers of the facility, a production schedule can be determined for each node 302 during a period of time in the future, where the production schedule ideally enables the facility to meet the demand as much as possible while minimizing transition costs associated with material production transitions dictated by the production schedule. The following discusses how this problem can be formulated as a mathematical optimization problem. After that, approaches for using the optimization problem are described, and post-processing operations that may be performed using one or more solutions to the optimization problem are described.

In order to determine an optimal production schedule, an optimization problem can be defined and solved. In order to define the optimization problem, a set of constraints and an objective or cost function of the optimization problem can be defined. The following describes example constraints that may be associated with the optimization problem, as well as an example objective or cost function that may be associated with the optimization problem.

In some embodiments, constraints corresponding to each node 302 in the production process may be determined as follows. As noted above, the set of materials that can be produced by a node i can be denoted as prodⁱ. The production schedule of these materials at the node i can be denoted as Aⁱ ϵ [symbol] ^{H×|prod}^{ⁱ}^{_{|}}, where H represents a time or schedule horizon. Each of multiple steps in the horizon may correspond to a period of time, such as one minute, fifteen minutes, etc. Using this notation, each column j of Aⁱ corresponds to a material produced at the node i, and each column of Aⁱ may be denoted as Aⁱ. Assuming positivity of production indicates that Aⁱ≥0 and that Aⁱ≤Mⁱ, where Mⁱ ϵ [symbol] ^{H×|prod}^{ⁱ}^{_{|}} denotes a maximum production capacity matrix at the node i for different materials at different times over the horizon. Also, as noted above, there is typically an associated minimum production rate for each node-material combination. That is, if producing a material at a node 302, the produced amount may be larger than some minimum amount. These features can be encoded as conditional constraints by introducing some binary variables, such as in the following manner:

$$\begin{matrix}{A}^{i} - {M}^{i} ⊙ {Y}^{i} \leq 0 & ( 1 ) \\ {A}^{i} - {L}^{i} ⊙ {Y}^{i} \geq 0 & ( 2 )\end{matrix}$$

Here, ⊙ represents a Hadamard or element-wise multiplication Yⁱ ϵ {0, 1}^{H×|prod}^{ⁱ}^{_{|}} represents a matrix of binary variables for encoding the constraints, and Lⁱ ϵ [symbol] ^{H×|prod}^{ⁱ}^{_{|}} represents the minimum production capacity matrix for materials produced at a node i over a horizon. In addition, assuming that one and only one material may be produced at a node 302 at any given time, this can be encoded as a constraint by adding the following to Equations (1) and (2):

$${Y}^{i} 1 \leq 1 \qquad ( 3 )$$

Notice that, in certain cases, Mⁱ=Lⁱ for all nodes 302. In this type of situation, the variables Aⁱ would not be needed to denote the amount of production, and it is possible to use only the binary variables Yⁱ. To see this, note that having Y_{zk}ⁱ=1 indicates that a material k is being produced at a time z using a node i. Given that, M_{zk}ⁱY_{zk}ⁱ represents the amount of material that will be produced at that time.

When determining a new production schedule, there may be constraints concerning the variability of the determined production schedules computed at one time to another time. Let Y̅^̅{̅l̅}̅ and A̅^̅{̅l̅}̅ represent variables encoding a previously-determined production schedule, and let t_{f} represent a frozen time fence that denotes a period of time during which changes are not made to the previously-determined production schedule. Based on this, the following may be used to enforce this constraint:

$$\begin{matrix}{Y}^{i} {\text{[:} \text{t}}_{f} - 1 \text{,:} ] = {\overline{Y}}^{i} [ {\text{1:} \text{t}}_{f} \text{,:} ] & ( 4 ) \\ {A}^{i} [ {\text{:} \text{t}}_{f} - 1 \text{,:} ] = {\overline{A}}^{i} [ {\text{1:} \text{t}}_{f} \text{,:} ] & ( 5 )\end{matrix}$$

Common matrix notation is used here for this purpose. This indicates that the variables involved in the constraints above can be removed from the optimization problem. Similarly, constraints enforcing planned or unplanned shutdowns of certain nodes 302 may be used. For example, this can be easily enforced by setting rows associated with shutdown periods at a node i in the horizon in Yⁱ and Aⁱ to zero. Note that introducing the constraints in Equations (4) and (5) above in order to enforce the frozen time fence may lead to constraint violations, particularly with respect to interaction constraints described below. In order to avoid an infeasible model, constraints in the optimization model for the first t_{f} timesteps can be relaxed.

In some cases, this can complete the list of constraints that describe the rules governing production at each node i. To summarize, below are the constraints corresponding to each node 302:

$${A}^{i} - {M}^{i} ⊙ {Y}^{i} \leq 0 \\ {A}^{i} - {L}^{i} ⊙ {Y}^{i} \geq 0 \\ {Y}^{i} 1 \leq 1 \\ {Y}^{i} {\text{[:} \text{t}}_{f} - 1 \text{,:} ] = {\overline{Y}}^{i} [ {\text{1:} \text{t}}_{f} \text{,:} ] \\ {A}^{i} [ {\text{:} \text{t}}_{f} - 1 \text{,:} ] = {\overline{A}}^{i} [ {\text{1:} \text{t}}_{f} \text{,:} ] \qquad ( 6 )$$

In some embodiments, constraints corresponding to each flow 304 in the production process may be determined as follows. These constraints may primarily focus on encoding the flows 304 of materials among the nodes 302. To do so, let Iₘ denote an m×m identity matrix, and let Eⁱ denote a matrix that is the result of selecting rows of Iₘ given by the ordered set prodⁱ. Also, let T^{i,k} represent an identity matrix I_{H} with its diagonal shifted downward by an amount Sᵢₖ. Notice that, in this setting, T^{k,i} would represent the identity matrix I_{H} with its diagonal shifted upward by the amount Sᵢₖ. Denote the flow 304 of material along the edge from a node i to a node k as F^{i,k}, and denote the flow 304 of material from the inventory 306 to the node i as F^{Inv,i} (where F^{i,Inv} is the reverse flow of material from the node i to the inventory 306). Denote the set of materials flowing along the edge from the node i to the node k as prod^{i,k}⊆prodⁱ. In addition, define a recipe matrix for the node i as Rⁱ ϵ [symbol] ^{m×m}, where the j^{th} column of the recipe matrix is denoted Rⱼ and describes how much of material j received by the node i is required for producing one or more downstream materials. For instance, if one unit of the material j is required to produce a₁ of material u and to produce a₂ of material v, the u^{th} and v^{th} components of Rⱼ may be equal to 1/a₁ and 1/a₂, respectively (where the rest of the values in Rⱼ would be zeros). Based on this, it is possible to define constraints describing the in-flow and out-flow of material to and from the node i as follows:

$$\begin{matrix}{A}^{i} = {\sum }_{k ∈ c h ( i )} {F}^{i , k} {E}^{i , k} & ( 7 ) \\ {A}^{i} {E}^{i} {R}^{i} = {\sum }_{k ∈ par ( i )} {T}^{k , i} {F}^{k , i} {E}^{k , i} {E}^{k} & ( 8 ) \\ {F}^{i , k} \geq 0 & ( 9 )\end{matrix}$$

Here, E^{i,k} represents I_{|prod}_{ⁱ}_{|} with selected rows given by the ordered set prod^{i,k}. Also, E^{Inv} represents a matrix obtained from Iₘ by keeping rows indexed by the ordered set ter. In addition, par(⋅) and eh(⋅) respectively represent a set of parent nodes and a set of children nodes for a specified node. Note that the constraint in Equation (8) would not be present for any nodes i where par(i)=0. Also note that it has been assumed here that the interactions of the nodes 302 with one another are static and that the interactions do not depend on the production schedule. In cases where this assumption is not valid, other constraints that encode such behaviors can be incorporated as described below.

Focus now turns to describing a cost function associated with the optimization problem. One aim of defining a cost function here can be to strike a balance between different objectives, such as (i) producing final products at the right times and delivering orders on time and (ii) reducing production costs, such as transition costs for shifting between producing different materials. In order to form a cost function successfully, some additional constraints and variables may be introduced. Let x₀ ϵ [symbol] ^{|ter|} represent the current inventory vector for finished products, and let D ϵ [symbol] ^{H×|ter|} represent a finished products demand forecast matrix ordered based on the ordered set ter. Given this, the evolution of inventory X over the time horizon can be expressed as follows:

$$X = {Δ}^{- 1} ( {e}_{1} {x}_{0}^{T} + {\sum }_{i ∈ par ( Inv )} {F}^{i , Inv} {E}^{i , Inv} {E}^{i} \times {( {E}^{Inv} )}^{T} - {\sum }_{i ∈ ch ( Inv )} {F}^{Inv , i} {E}^{Inv , i} \times {( {E}^{Inv} )}^{T} - D ) \qquad ( 10 )$$

Here, Δ⁻¹ represents a lower-triangular matrix with only ones in the lower triangle, e₁ ϵ {0, 1}^{H} represents a vector with a one as its first element, and ch(Inv) represents the nodes 302 that can post-process final products from the inventory 306. In order to satisfy the demand D, the following can be obtained:

$${Δ}^{- 1} ( {e}_{1} {x}_{0}^{T} + {\sum }_{i ∈ par ( Inv )} {F}^{i , Inv} {E}^{i , Inv} {E}^{i} \times {( {E}^{Inv} )}^{T} - {\sum }_{i ∈ ch ( Inv )} {F}^{Inv , i} {E}^{Inv , i} \times {( {E}^{Inv} )}^{T} - D ) \geq 0 \qquad ( 11 )$$

However, the aim may not necessarily be to satisfy all demand on time since it is possible to miss on demand and pay a penalty. In order to encode this, additional variables X₊,X₋ ϵ [symbol] ^{H×|ter|} can be introduced to represent the positive and negative components of the inventory X. Equation (11) may then be modified as follows:

$$\begin{matrix}{X}_{+} - {X}_{-} = {Δ}^{- 1} ( {e}_{1} {x}_{0}^{T} + {\sum }_{i ∈ par ( Inv )} {F}^{i , Inv} {E}^{i , Inv} {E}^{i} \times {( {E}^{Inv} )}^{T} - {\sum }_{i ∈ ch ( Inv )} {F}^{Inv , i} {E}^{INv , i} \times {( {E}^{Inv} )}^{T} - D ) & ( 12 ) \\ {X}_{+} - {X}_{-} \geq 0 & ( 13 )\end{matrix}$$

With these, it is possible to describe the terms of a cost function that relate to producing the final products at the right times and delivering orders on time. Before doing so, consider the penalization process of missed demand or early production. Assuming that a demand is expected to be satisfied at a time t for a product i, a penalty function in some cases may be defined as follows:

$$p ( τ ) = \{ \begin{matrix}{c}_{h}^{i} & if t \geq τ \\ f ( τ - t ) & if t < τ\end{matrix} \qquad ( 14 )$$

This encoding indicates that, if the product i is produced earlier than needed, the penalty is a linear inventory holding cost. If the product i is produced later than needed, the penalty is a nonlinear function based on delay (which is often expressed as a nonlinear function that is exponential based on delay). The nonlinear function based on delay might be approximated to be linear, such as with a penalty coefficient α ϵ [symbol] . The related terms in the cost function can then be defined as follows:

$${1}^{T} {X}_{+} {C}_{h} 1 + α {1}^{T} {X}_{-} 1 \qquad ( 15 )$$

Here, the first term encodes the penalty associated with early production (inventory holding cost) with Cₕ being a diagonal matrix and cₕⁱ being its diagonal entries, and the second term encodes the penalty associated with late production.

In terms of reducing the transition cost portion of the production costs, assume the matrices Cⁱ that define the transition costs associated with material production at a node i are symmetric. In that case, the following can encode the transition cost associated with production across all nodes 302:

$$- \frac{1}{2} {1}^{T} [ {\sum }_{i = 1}^{N} Δ {Y}^{i} {E}^{i} {{C}^{i} ( Δ {Y}^{i} {E}^{i} )}^{T} ] 1 \qquad ( 16 )$$

where N represents the number of nodes 302. In this case, the total cost function can be written as follows:

$${1}^{T} {X}_{+} {C}_{h} 1 + α {1}^{T} {X}_{-} 1 - \frac{1}{2} {1}^{T} [ {\sum }_{i = 1}^{N} Δ {Y}^{i} {E}^{i} {{C}^{i} ( Δ {Y}^{i} {E}^{i} )}^{T} ] 1 \qquad ( 17 )$$

Now assume that the transition cost matrices Cⁱ are not symmetric. In that case, additional constraints and variables can be introduced to support formulation of the cost function. For example, the following constraints may be used:

$$\overline{Δ} {Y}^{i} = {Y}_{+}^{i} - {Y}^{\underline{i}} \qquad ( 18 )$$

Here, Δ̅ represents the matrix Δ with the first row removed, Y₊ⁱ,Y₋ⁱ ϵ [symbol] ^{H-1×|prod}^{ⁱ}^{_{|}}, and Y₊ⁱ,Y₋ⁱ≥0. The material transition cost portion of the cost function can then be formulated as follows:

$${\sum }_{i = 1}^{N} {vec ( {( {Y}^{\underline{i}} {E}^{i} )}^{T} )}^{T} {C}^{i} v ec ( {( {Y}_{+}^{i} {E}^{i} )}^{T} ) \qquad ( 19 )$$

Here, vec(⋅) represents a vectorization operation, and Cⁱ ϵ [symbol] ^{Hm×Hm} represents a block-diagonal matrix with Cⁱ repeated as its diagonal blocks. In this case, the total cost function can be written as follows:

$${1}^{T} {X}_{+} {C}_{h} 1 + α {1}^{T} {X}_{-} 1 + {\sum }_{i = 1}^{N} v e {c ( {( {Y}_{-}^{i} {E}^{i} )}^{T} )}^{T} {C}^{i} vec ( {( {Y}_{+}^{i} {E}^{i} )}^{T} ) \qquad ( 20 )$$

With respect to additional logistical constraints, an inventory balance constraint was introduced above in Equation (12). This constraint alone permits an out-flow Σ_{iϵch(Inv)}F^{Inv,i}E^{Inv,i}×(E^{Inv})^{T} to exceed the amount of available inventory X₊. To prevent this, an additional constraint can be added, such as the following constraint:

$${X}_{+} - {\sum }_{i ∈ ch ( Inv )} {F}^{Inv , i} {E}^{Inv , i} \times {( {E}^{Inv} )}^{T} \geq 0 \qquad ( 21 )$$

Additionally, there may be certain logics that concern the utilization of equipment represented by the nodes 302. For instance, sets of nodes 302 may be coupled together such that they need to be producing materials simultaneously. Let i, k represent a set of coupled nodes, and let L represent the set of sets of coupled nodes. With these definitions, the following constraint can be defined to ensure that coupled nodes are producing simultaneously:

$${1}^{T} {Y}^{i} = {1}^{T} {Y}^{k} , ∀ ( i , k ) ∈ ℒ \qquad ( 22 )$$

Another constraint may involve one or more sets of exclusive edges (flows 304), each of which can be defined as a set of edges where only one member edge can have a non-zero flow along it at any given time. To encode this constraint, a binary variable y^{i,k} ϵ {0, 1}^{H} can be introduced, which captures whether edge (i, k) has a non-zero flow for each timestep. Based on this, the following constraints can be defined:

$$\begin{matrix}{F}^{i , k} 1 - M ⊙ {y}^{i , k} \leq 0 , ∀ ( i , k ) ∈ \overline{ɛ} & ( 23 ) \\ {Y}^{e x c} 1 \leq 1 & ( 24 )\end{matrix}$$

Here, [symbol] ϵ [symbol] is a large number, and Y^{exc} ϵ [symbol] ^{H×|exc|} represents a matrix whose columns correspond to each y^{i,k} in a set of exclusive edges exc. The first constraint ensures that y^{i,k} is active if there is any flow F^{i,k}, while the second constraint ensures that only one of the edges in the exclusive set exc is active at any given time.

Note that the description above describes variables, constraints, and objective terms that fully describe the dynamics and costs for a production scheduling problem. However, there are a few edge cases from the resulting optimal schedules that may need to be defended against. These edge cases are described below, and modifications to the problem formulation and parametrization are presented to address them.

First, consider the objective term that describes product transition costs as defined in Equation (19) above. This correctly captures the cost of a transition from a product m₁ to a product m₂ on consecutive timestamps. Notice that no transition cost is incurred when stopping production, nor is a transition cost incurred when restarting production. Therefore, transition costs between producing the products m₁ and m₂ can be entirely avoided by simply not producing for a single timestamp between the two production timestamps, meaning Y[t, :]=0. In the case of expensive transition costs, a low serviceability penalty, or a sufficiently-small time step discretization, the cost associated with not producing for a single time step may be entirely offset by not incurring the transition cost. In order to support this, a virtual material can be introduced, where the virtual material corresponds to a decision to not produce any physical material. Equation (3) may then be reformulated as follows:

$${\hat{Y}}^{i} 1 = 1 \qquad ( 25 )$$

where Ŷⁱ ϵ {0, 1}^{X×|prod}^{ⁱ}^{_{+1|}} represents Yⁱ with an additional column for the virtual material appended to the end. The reformulated constraint now ensures the ability to identify time steps where no material is being produced. A new transition cost matrix Ĉⁱ ϵ [symbol] ^{(|prod}^{ⁱ}^{_{|+1)×(|prod}}^{ⁱ}^{_{|+1)}} can be defined, which includes transition costs associated with the virtual material. To discourage transitions where production is turned off for a single time step, the value of Ĉⁱ[:−1, −1] can be set equal to β, where β ϵ [symbol] ₊ is more expensive than the most expensive transition in Ĉⁱ, ∀i ϵ [symbol] . The value of Ĉⁱ[−1, :] can be set to zero in order to not penalize turning on production. An updated transition cost term may then be expressed as follows:

$${\sum }_{i = 1}^{N} {vec ( {( {\hat{Y}}^{\underline{i}} {E}^{i} )}^{T} )}^{T} {\hat{C}}^{i} vec ( {( {\hat{Y}}_{+}^{i} {E}^{i} )}^{T} ) \qquad ( 26 )$$

Note that substituting Yⁱ ϵ {0, 1}^{H×|prod}^{ⁱ}^{_{|}} for f Ŷⁱ ϵ {0, 1}^{H×|prod}^{ⁱ}^{_{+1|}} in the problem formulation can involve careful consideration of the dimensions of different mathematical artifacts, such as Eⁱ, to avoid dimension mismatches.

Second, another issue may arise with respect to an inventory holding cost. It is possible for a terminal or final product to also represent an intermediate product, meaning a product that is stored in inventory 306 can also be consumed by a node 302 to create a new product. Let m_{ingr} represent one of such products. The objective term used to describe inventory holding cost is shown on the left-hand side of Equation (15) above. In the event of similar holding costs between m_{ingr} and a product m_{final} that is produced from m_{ingr}, it is possible to reduce the inventory holding cost by continually producing m_{final} by consuming m_{ingr} from the inventory 306. This is possible because the process of producing m_{final} reduces the inventory by an amount corresponding to the consumption rate of m_{ingr} and the time it takes for the product to make a round trip between the inventory 306 and a production node 302. To avoid this, the holding costs of all terminal or final products that are also intermediate products can be set to zero, which can be expressed as follows:

$${C}_{h} [ m , m ] = 0 , ∀ m ∈ p r o {d}^{ter} ⋂ {prod}^{i n t} \qquad ( 27 )$$

Here, prod^{int} represents the set of intermediate materials.

Third, as a final precaution, it may be desirable to schedule production for materials that are needed for the purposes of satisfying demand. To do this, a small penalty on production can be defined and added to the objective function, such as in the following manner:

$$γ {\sum }_{i = 1}^{N} {1}^{T} {Y}^{i} 1 \qquad ( 28 )$$

Here, γ ϵ [symbol] ₊ is a small number, such as a value of one. This ensures that unnecessary production is avoided but that the penalty on production is not large enough to offset more relevant costs (such as those associated with transitions or serviceability).

From all of the above, collecting the constraints defined above and putting the cost function together may result in the following optimization problem:

$$\begin{matrix}{minimize}_{{A}^{i} , {Y}^{i} , {Y}_{+}^{i} , {Y}_{-}^{i} , {F}^{i , k} , {y}^{i , k} , {X}_{+} , {X}_{-}} {1}^{T} {X}_{+} {C}_{h} 1 + α {1}^{T} {X}_{-} 1 + \\ {\sum }_{i = 1}^{N} v e {c ( {( {Y}_{-}^{i} {E}^{i} )}^{T} )}^{T} {C}^{i} v e c ( {( {Y}_{+}^{i} {E}^{i} )}^{T} ) + γ {\sum }_{i = 1}^{N} {1}^{T} {Y}^{i} 1 \\ subject \text{to:} \\ {A}^{i} \geq 0 , i ∈ \overline{V} ∖ \{ l nv \} \\ {A}^{i} - {M}^{i} ⊙ {Y}^{i} \leq 0 , i ∈ \overline{V} ∖ \{ Inv \} \\ {A}^{i} - {L}^{i} ⊙ {Y}^{i} \geq 0 , i ∈ \overline{V} ∖ \{ Inv \} \\ {Y}^{i} 1 = 1 , i ∈ \overline{V} ∖ \{ Inv \} \\ {1}^{T} {Y}^{i} = {1}^{T} {Y}^{k} , ∀ ( i , k ) ∈ ℒ \\ {Y}^{i} {\text{[:} \text{t}}_{f} - 1 \text{,:} ] = {\overline{Y}}^{i} [ {\text{1:} \text{t}}_{f} \text{,:} ] \\ {A}^{i} {\text{[:} \text{t}}_{f} - 1 \text{,:} ] = {\overline{A}}^{i} [ {\text{1:} \text{t}}_{f} \text{,:} ] \\ {A}^{i} = {\sum }_{k ∈ c h ( i )} {F}^{i , k} {E}^{i , k} , i ∈ \overline{V} ∖ \{ Inv \} \\ {A}^{i} {E}^{i} {R}^{i} = {\sum }_{k ∈ par ( i )} {T}^{k , i} {F}^{k , i} {E}^{k , i} {E}^{k} , i ∈ \overline{V} ∖ \{ i \vert p a r ( i ) = 0 \} \\ {F}^{i , k} \geq 0 , ∀ ( i , k ) ∈ \overline{ɛ} \\ {F}^{i , k} - ℳ ⊙ {y}^{i , k} \leq 0 , ∀ ( i , k ) ∈ \overline{ɛ} \\ {Y}^{e x c} 1 \leq 1 \\ Δ {Y}^{i} = {Y}_{+}^{i} - {Y}_{-}^{i} , i ∈ \overline{V} ∖ \{ Inv \} \\ {Y}_{+}^{i} , {Y}_{-}^{i} \geq 0 , i = 1 , . . . , N \\ {X}_{+} - {X}_{-} = {Δ}^{- 1} ( {e}_{1} {x}_{0}^{T} + {\sum }_{i ∈ par ( Inv )} {F}^{i , Inv} {E}^{i , Inv} {E}^{i} \times {( {E}^{Inv} )}^{T} - {\sum }_{i ∈ ch ( Inv )} {F}^{Inv , i} {E}^{Inv , i} \times {( {E}^{Inv} )}^{T} - D ) & ( 29 ) \\ {X}_{+} - {\sum }_{i ∈ ch ( Inv )} {F}^{Inv , i} {E}^{Inv , i} \times {( {E}^{Inv} )}^{T} \geq 0 & \\ {X}_{+} , {X}_{-} \geq 0 & ( 30 )\end{matrix}$$

Note that the cost function in Equation (29) includes bilinear terms due to the last term. This means that this problem constitutes a mixed integer nonlinear program (MINP). In some cases, the MINP problem can be converted into a mixed integer linear program (MILP), such as by using McCormick envelopes or relaxations. In other cases, approaches that modify the cost function to convert the problem into a mixed integer quadratic program (MIQP) may be used. Details of these approaches are now provided.

With respect to McCormick envelopes or relaxations, consider a bilinear term xᵢxⱼ. Bilinear terms are some of the most innocent forms of nonlinearity, and such terms may be approximated by introducing an additional variable and four linear inequality constraints. Assume that xᵢ ϵ [lᵢ,uᵢ] and xⱼ ϵ [lⱼ,uⱼ]. Also assume that a variable Wᵢⱼ represents the interaction. Given this, the convex hull for the nonlinear equality constraint Wᵢⱼ=xᵢxⱼ can be expressed as follows:

$$\begin{matrix}- {W}_{i j} + {l}_{j} {x}_{i} + {l}_{i} {x}_{j} \leq {l}_{i} {l}_{j} & ( 31 ) \\ - {W}_{i j} + {u}_{j} {x}_{i} + {u}_{i} {x}_{j} \leq {u}_{i} {u}_{j} & ( 32 ) \\ {W}_{i j} - {u}_{j} {x}_{i} - {l}_{i} {x}_{j} \leq - {l}_{i} {u}_{j} & ( 33 ) \\ {W}_{i j} - {l}_{j} {x}_{i} - {u}_{i} {x}_{j} \leq - {u}_{i} {l}_{j} & ( 34 )\end{matrix}$$

Here, the variables that are in the bilinear terms are in fact binary variables, so the constraints above can be reduced as follows:

$$\begin{matrix}- {W}_{i j} \leq 0 & ( 35 ) \\ - {W}_{i j} + {x}_{i} + {x}_{j} \leq 1 & ( 36 ) \\ {W}_{i j} - {x}_{i} \leq 0 & ( 37 ) \\ {W}_{i j} - {x}_{j} \leq 0 & ( 38 )\end{matrix}$$

Note that, for binary variables, these constraints are equivalent to Wᵢⱼ=xᵢxⱼ. To observe this, the four different combinations of xᵢ and xⱼ can be enumerated, and it can be observed that bilinear equality is derived from Equation (35) for all cases. Based on this, it is possible to introduce additional variables and constraints to convert the MINP above to an MILP. However, for long horizons or when each node 302 can produce many materials, this approach results in many additional variables and constraints. In fact, the number of constraints and variables can grow quadratically as a function of horizon and the number of materials at each node 302. Thus, the following alternative approach can be used for such cases in some embodiments.

Notice that the bilinear term in the cost function can be equivalently rewritten as follows:

$$\frac{1}{2} {{Σ}_{i = 1}^{N} [ \begin{matrix}vec ( {( {Y}_{+}^{i} {E}^{i} )}^{T} ) \\ vec ( {( {Y}_{-}^{i} {E}^{i} )}^{T} )\end{matrix} ]}^{T} [ \begin{matrix}0 & {( {C}^{i} )}^{T} \\ {C}^{i} & 0\end{matrix} ] [ \begin{matrix}v ec ( {( {Y}_{+}^{i} {E}^{i} )}^{T} ) \\ vec ( {( {Y}_{-}^{i} {E}^{i} )}^{T} )\end{matrix} ] \qquad ( 39 )$$

Although this defines a quadratic term, this still represents an MINP since the Hessian is indefinite. In order to evade this issue, the Hessian can be modified to become diagonally-dominant by adding positive values to the diagonal. This could be as simple as adding a positive multiple of an identity matrix to the Hessian, which results in the same positive diagonal value. More sophisticated approaches may also be used, such as by picking different values for the diagonal. Note that the positive diagonals encode the cost associated with production. Since the production is enforced by the constraints that enforce satisfaction of the demand and the penalty associated with missing demand, this approximation may have minimal effect on the solution.

Note that the above description has described the production scheduling optimization problem as a mathematical algorithm to the fullest extent possible. However, there may be several practical limitations of this approach. One limitation is the computational complexity of the formulation since the approach defined above is a mixed integer quadratic program and can easily have millions of variables and non-zero objective and constraint terms. For a problem of this complexity, even state-of-the-art optimization solvers can have difficulty converging to near-optimal solutions in a reasonable amount of time. It may be possible to improve solve times with tricks such as warm-starting the solver from a relaxed solution, normalizing coefficients to be in a narrower range (such as 10⁵), and tweaking solver parameters. Heuristics, such as receding horizon optimization where the scheduling horizon is discretized into shorter periods and solved sequentially, may also be used. While these approaches provide improvements to the solve times, they still face significant issues around scalability. Other limitations may revolve around modeling. For instance, within the mathematical programming framework, it can be difficult to encode constraints such as variable changeover times between product transitions, quantity-driven batch-size requirements for production, and nonlinear serviceability costs.

For these reasons, a two-module or two-step scheduling algorithm or process may be used. The first module or step can be responsible for solving a relaxed version of the optimization problem described above. For example, the transition cost term in Equation (19), along with associated variables and constraints, can be removed from the problem formulation. It is also possible to remove consideration of changeover times from the problem formulation. The resulting problem is a much more tractable mixed integer linear program. The second module or step can be responsible for post-processing the relaxed solution into a feasible and near-optimal production schedule. For instance, the post-processing module or step may be responsible for optimizing transition costs and capturing the previously-mentioned modeling limitations with respect to a representative cost function. The mechanics and operations that may be performed by the post-processing module or step are described below.

Although FIGS. 3A and 3B illustrate examples of graph representations 300a-300b of equipment and equipment interactions in a facility, various changes may be made to FIGS. 3A and 3B. For example, a graph representation of a facility may include any suitable number and arrangement of nodes 302, any suitable number and arrangement of flows 304, and any suitable number and arrangement of inventories 306. Also, other optimization problems may be defined using the same or similar approach as that described above.

As described above, several relaxations can be made to the optimization problem's formulation, such as due to modeling or computational constraints. In order to produce a truly feasible and optimal production schedule using the relaxed optimization problem, post-processing can be performed to modify a production schedule generated using the relaxed optimization problem. In some embodiments, the post-processing can honor the constraints that are not directly encoded in the optimization problem's formulation of Equations (29)-(30) and optimize the true objective function, which can include nonlinear serviceability and transition costs. Constraints that may not be directly encoded into the optimization problem's formulation may include the following: (i) for a production batch defined as a continuous duration producing a single material, the total quantity produced in the production batch may need to be an integer multiple of some production unit; (ii) consecutive production batches of different materials may have a non-negative downtime, which is defined as a period of time where material is not being produced; and (iii) consecutive production batches of different materials may have a non-negative transition time immediately following a downtime, and a transition product may be produced during the transition time and optionally stored in the inventory 306. It should be noted here that the relaxed optimization problem satisfies mass balance (besides transition materials) across all nodes 302 and can be optimized directly for serviceability costs. Therefore, it may be reasonable in some cases to assume that sufficient production has been scheduled to satisfy demand, and the post-processing can focus on modifying the production schedule to be feasible and optimal without introducing or removing a significant amount of production.

In some embodiments, the post-processing that is performed once a production schedule (referred to as a relaxed optimization schedule) has been generated using the relaxed optimization problem can include a series of sequential or other steps or operations. Each step or operation can be responsible for modifying the relaxed optimization schedule to have some quality of a feasible and optimal production schedule. The following are examples of the types of steps or operations that may occur as part of the post-processing functionality, and each of these steps or operations is described in more detail below. During a “chunk and merge” operation, the relaxed optimization schedule may be divided or discretized into separate chunks, and batches of common products in each chunk may be merged. During a “resequence” operation, production batches may be reordered so as to reduce or minimize transition costs within each chunk. During a “round to production unit” operation, all production batches in the schedule may be rounded to integer multiples of some production unit. During an “inject time gap” operation, downtimes and transition times may be introduced into the schedule. During an “align auxiliary nodes to parent nodes” operation, production batches on auxiliary nodes may be aligned to their parent nodes' production. During an “align auxiliary nodes to inventory” operation, production batches on auxiliary nodes may be aligned to ingredients available in the inventory 306. During a “shift and merge” operation, a search for a locally-optimal schedule may be performed via merging of production batches. During an “inject transition material” operation, any production of one or more transition materials during a transition time may be reflected in the production schedule. Note that the post-processing of a solution to an optimization problem may involve the use of one of these post-processing operations, all of these post-processing operations, or any combination of these post-processing operations.

To aid in the performance of these post-processing operations, it may be helpful to represent a relaxed production schedule in a way that is different from the optimization described above. In the optimization, the production schedule may be represented as a matrix whose rows represent timesteps and whose columns represent products or materials. Despite the data compactness of the matrix, using a matrix representation of batches and production schedules raises the following considerations. First, with respect to batch consistency, it may be necessary or desirable to ensure that child and parent batches (such as in the case of a product and the ingredients it requires) are consistent. When a batch of material is removed from a production schedule, any associated batches at upstream or downstream nodes 302 may also need to be removed in order to satisfy mass balance constraints, and checking which submatrix needs to be removed may be very error-prone and complex. Second, with respect to computational efficiency, when a batch of material is removed from or added to a production schedule, a new matrix may have to be constructed, which could require O(n) time. Considering (i) the matrix-format production schedule has dimensions of the time horizon and the number of items and (ii) the high frequency at which insertion and removal operations may be performed, exclusively using a matrix representation of a production schedule may be highly inefficient.

To address these or other issues and introduce more extensibility, in some embodiments, a recursive doubly-linked list data structure may be used to represent batches of materials to be produced. Each batch can have attributes such as its material, quantity, and duration. Additionally, there are often references to preceding and subsequent batches of materials within a production schedule, as well as references to one or more batches of materials that are used as one or more ingredients or that are created from a specific batch. A production schedule may therefore be represented as a container of batches. This type of data structure has O(l) insertion and removal times. Benefiting from its recursive structure, when a specified batch is removed, removal of any associated batches is very simple and can be directly handled by the data structure with a time complexity of O(k), where k represents the number of total schedules in a sequence.

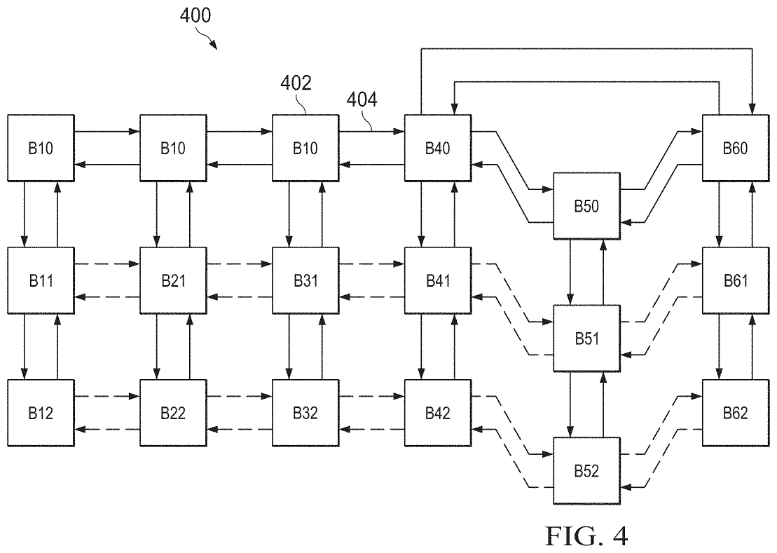

FIG. 4 illustrates example insertion and removal operations involving a data structure 400 representing batches of materials in a production schedule according to this disclosure. As shown in FIG. 4, the data structure 400 uses blocks 402 to represent different batches of materials and pointers 404 to identify relationships between the different batches of materials. Two pointers 404 are used to identify each relationship between two batches of materials, making the data structure 400 a doubly-linked list data structure. In this particular example implementation, each row of blocks 402 may represent a production schedule for a particular node 302, and different rows of blocks 402 can represent the production schedules for different nodes 302. Also, relationships between rows represent parent-child relationships between nodes 302 and their associated batches. For example, a batch B10 can be used as an ingredient for a batch B31, and the batch B31 can be used as an ingredient for a batch B32. Insertions and removals of batches of materials can be performed by simply modifying linkages at the same level and across level batch neighbors without copying the entire production schedule. Thus, for instance, inserting or removing a batch B50 and its related batches B51 and B52 may simply involve creating or deleting the appropriate blocks 402 and adjusting the pointers 404 to the left and right of each batch B50-B52.

Although FIG. 4 illustrates one example of insertion and removal operations involving a data structure 400 representing batches of materials in a production schedule, various changes may be made to FIG. 4. For example, a data structure 400 may include any suitable number and arrangement of blocks 402 and any suitable number and arrangement of pointers 404. Also, any other suitable data structure(s) may be used to represent batches of materials in a production schedule.

With respect to the “chunk and merge” post-processing operation, a relaxed optimization schedule produced using a relaxed version of the optimization problem formulation in Equations (29)-(30) can represent a production schedule with many transitions between productions of different batches of different materials, which can lead to extremely high transition costs. To combat the high transition costs associated with the relaxed optimization schedule, the application server 106 may perform the “chunk and merge” operation, which generally operates to combine batches of common materials into larger batches of the same materials. In some cases, this can be performed as follows. First, the relaxed optimization schedule can be divided or discretized into chunks with relatively-small time windows. Second, within each chunk, batches of common materials can be merged together into larger batches.

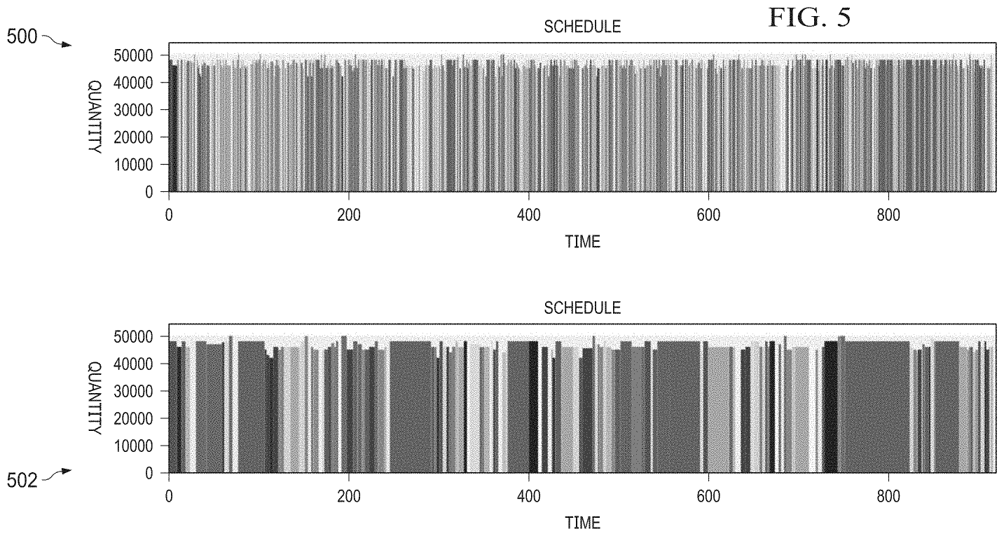

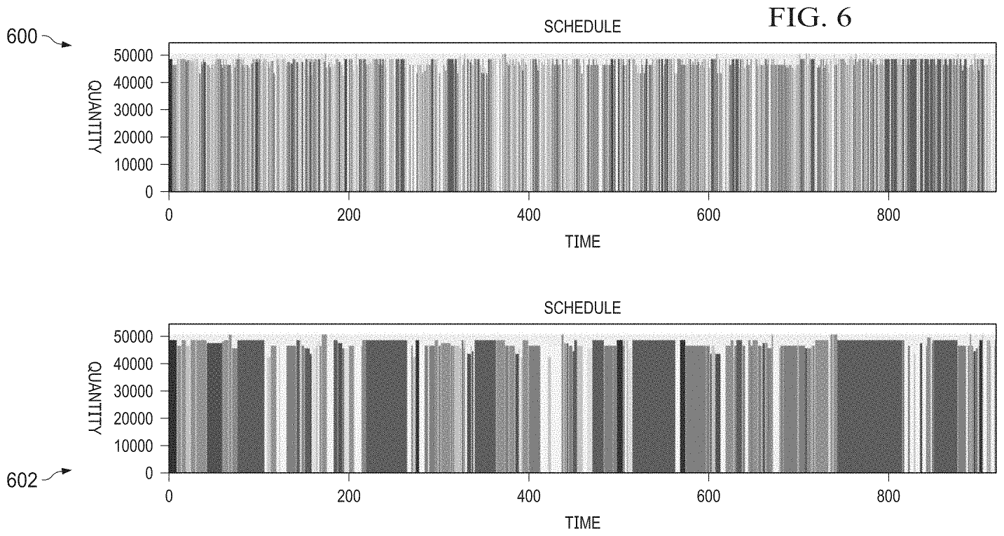

FIGS. 5 and 6 illustrate example results obtained using a chunk and merge process to combine batches of common materials in a production schedule according to this disclosure. As shown in FIG. 5, a graph 500 plots the production of different materials by a parent node 302 within a relaxed optimization schedule, and a graph 502 plots the production of the different materials by the parent node 302 after the “chunk and merge” operation is performed using the relaxed optimization schedule. Similarly, as shown in FIG. 6, a graph 600 plots the production of different materials by a child node 302 within the relaxed optimization schedule, and a graph 602 plots the production of the different materials by the child node 302 after the “chunk and merge” operation is performed using the relaxed optimization schedule. As can be seen here, there are numerous transitions between different materials in the graphs 500 and 600, while there are far fewer transitions between different materials in the graphs 502 and 602. This indicates that the “chunk and merge” operation can significantly reduce the number of batches (which reduces transition costs) while maintaining the approximate timing for the batches' production (which limits the degree to which serviceability costs increase).

Although FIGS. 5 and 6 illustrate examples of results obtained using a chunk and merge process to combine batches of common materials in a production schedule, various changes may be made to FIGS. 5 and 6. For example, a relaxed optimization schedule may involve any suitable number of materials and any suitable number of transitions between materials. Also, the results of the chunk and merge process may vary based on a number of factors, such as the specific relaxed optimization schedule being processed and the size of each chunk.

With respect to the “resequence” post-processing operation, the chunk and merge process reduces transition costs by combining production batches for common materials in order to reduce the total number of production batches. As a result, the chunk and merge process may not optimize the sequence of batches within each chunk. Therefore, the “resequence” operation can be performed following the chunk and merge process, and the “resequence” operation generally operates to reorder production batches to further reduce transition costs. In some cases, the “resequence” operation involves the use of a resequence cost minimization problem, which may be defined as follows. Given a set of unique materials, a transition cost matrix C can be defined, where the elements C_{i,j} of the transition cost matrix represent the transition costs from a material i to a material j. Using this transition cost matrix C, the application server 106 can find the order of producing the materials that yields the lowest total transition cost.

In some embodiments, this minimization problem can be viewed as the classical traveling salesperson problem (TSP), where cities represent the different materials to be produced and distances between the cities represent the transition costs incurred between different pairs of materials. In particular embodiments, the starting city may represent a dummy material, which can have a zero distance to all actual cities. This may allow an optimal solution to be identified that is not dependent on a specific material being selected as the starting material. Since the time chunk size is generally small and contains a relatively small number of unique materials, an exact solver that utilizes branch and cut with dynamic programming may be used here. Note that it is also possible to cast the TSP as a mixed integer linear program, such as by using the Miller-Tucker-Zemlin formulation, in which case the “resequence” operation may be implemented using such an optimization approach.

In some cases, a search state can be represented as a pair that includes a sorted list of assigned materials and a set of remaining materials, and an optimal sequence of remaining materials may only rely on the most recently assigned material. Using this search state representation, repeat searches can be avoided. To further reduce redundant searches, if an incomplete sequence already exceeds the current best solution, this search can be trimmed. An example implementation of such an algorithm, along with its pseudocode, is provided below.

Algorithm 1: Minimum Cost Resequence

| | Input: Unique set of materials of size n, M . |
|---|---|
| | Cost matrix C , that C[i][j] represent cost of making transition |
| | from i to j |
| | Result: Sequence of material S that minimize the overall transition |
| | cost |
| | Minimum cost L for the result sequence S |
| 1 | initialize record R = { } which memorize the best solution of |
| | a search state; |
| 2 | initialize dummy start material M₀ ∉ M with zero transition |
| | cost to Mᵢ ∈ M; |
| 3 | initialize initial cut branch bound B = inf ; |
| 4 | initialize current best sequence V = [M₀] ; |
| 5 | S, L = recursive resequence(V, M, C, B, R); |
| 6 | return S, L |

Algorithm 2: Recursive Minimum Cost Resequence

| | Input: Previous best sequence Vₜ₋, Unique set of materials of size n, Mₜ₋ . | | | |
|---|---|---|---|---|
| | | | Cost matrix C , that C[i][j] represent cost of making transition from i to j | |
| | | | Branch cut upper bound Bₜ₋, Resequence subproblem solution records R | |
| | Result: Sequence of material S that minimize the overall transition cost | | | |
| | | | Minimum cost L for the result sequence S | |
| 1 | if M = = { } then | | | |
| 2 | └ | return [ ], 0 | | |
| 3 | search state r is a tuple of (Vₜ₋[−1], sorted M) ; | | | |
| 4 | if r ∉ R or ( R[r].cost = = inf and R[r].bound < Bₜ₋) then | | | |
| 5 | \| | define the recursive minimum cost resequence function as f; | | |
| 6 | \| | initialize best next material with null ; | | |
| 7 | \| | initialize best afterward sequence as [ ] ; | | |
| 8 | \| | initialize the overall best cost as cₘᵢₙ = Bₜ₋ ; | | |
| 9 | \| | initialize found solution flag as false ; | | |
| 10 | \| | for mᵢ ∈ M do | | |
| 11 | \| | \| | mₜ₋ = Vₜ₋ [−1] ; | |
| 12 | \| | \| | cₜ = C[mₜ₋][mᵢ]; | |
| 13 | \| | \| | if cₜ > Bₜ₋ then | |
| 14 | \| | \| | └ continue | |
| 15 | \| | \| | new upper bound Bₜ= Bₜ₋ −c ; | |
| 16 | \| | \| | new sequence Vₜ= Vₜ₋+[mᵢ] ; | |
| 17 | \| | \| | new material set Mₜ = deep copy of Mₜ₋ ; | |
| 18 | \| | \| | remove mᵢ from Mₜ; | |
| 19 | \| | \| | afterward sequence Vₜ₊, afterward cost cₜ₊ = f(Vₜ, Mₜ, C, Bₜ, R) ; | |
| 20 | \| | \| | current overall transition cost l = cₗ + cₜ₊ ; | |
| 21 | \| | \| | if l < cₘᵢₙ then | |
| 22 | \| | \| | \| | found solution flag is true; |
| 23 | \| | \| | \| | best next is mᵢ ; |
| 24 | \| | \| | \| | best afterward sequence is Vₜ₊; |
| 25 | \| | └ | └ | best overall cost cₘᵢₙ = l |

| 26 | \| | define a search result s = (sequence=[ ], cost=inf, bound=Bₜ₋ ); | |
|---|---|---|---|
| 27 | \| | if found solution flag is true then | |
| 28 | \| | \| | s.sequence = [best next material] + best afterward sequence; |
| 29 | \| | \| | s.cost = cₘᵢₙ; |
| 30 | \| | └ | s.bound = cₘᵢₙ; |

| | | |
|---|---|---|
| 31 | └ | R[r] = s |

| | |
|---|---|
| 32 | return R[r].sequence, R[r].cost |

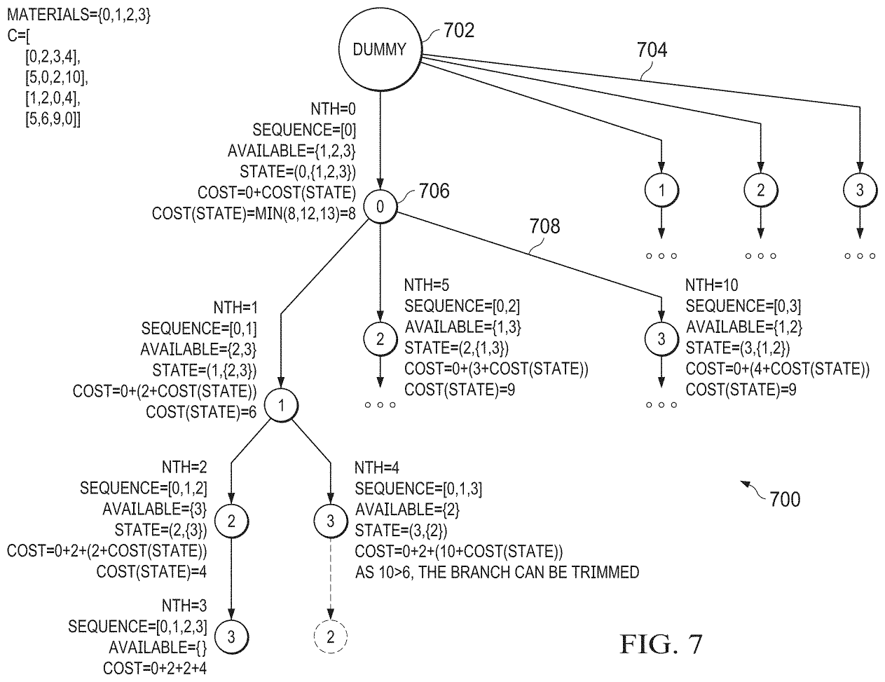

FIG. 7 illustrates example search results 700 obtained using a resequence process to change the order of batches of materials in a production schedule according to this disclosure. As shown in FIG. 7, the search starts at a dummy node 702, which represents a dummy material having a “distance” of zero to each of four materials {0, 1, 2, 3} to be produced. Branches 704 from the dummy node 702 lead to other nodes 706, which represent the actual materials to be produced. Other branches 708 involving the nodes 706 represent possible transitions between productions of different materials. Each subtree under the dummy node 702 represents a possible production ordering of the batches of the four materials {0, 1, 2, 3}, and each subtree can have a total transition cost that represents a sum all transition costs for the production transitions defined by that subtree. Selecting the subtree with the lowest total transition cost can define the order of the materials that should be used by the “resequence” to reorder the batches in an associated chunk.

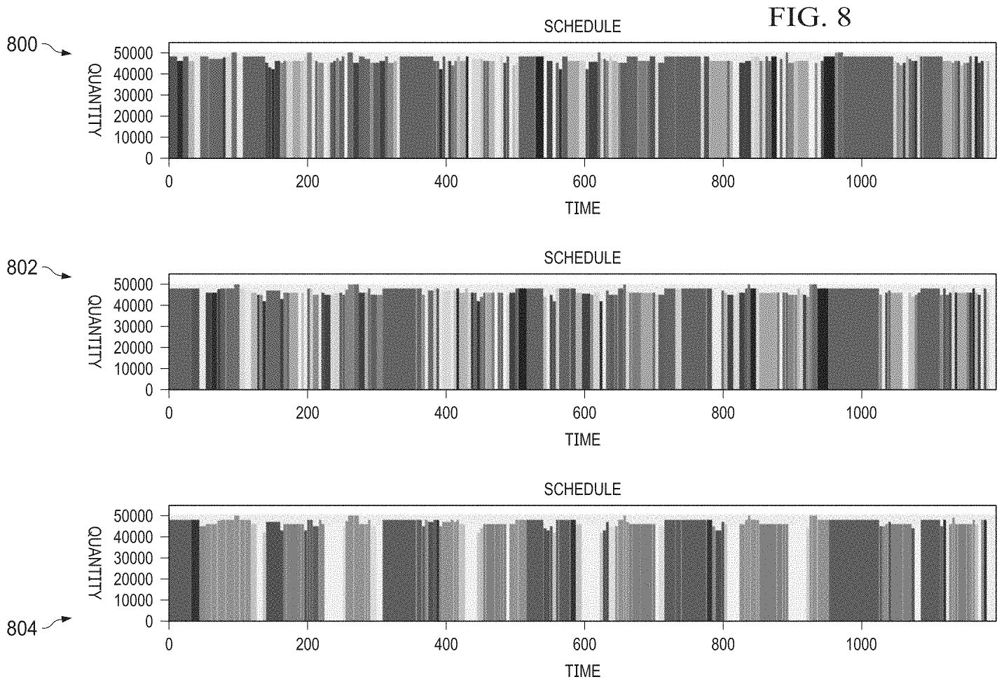

FIG. 8 illustrates example results obtained using a resequence process to change the order of batches of materials in a production schedule according to this disclosure. As shown in FIG. 8, a graph 800 plots the production of different materials by a downstream node 302 prior to the “resequence” operation, and a graph 802 plots the production of different materials by the downstream node 302 after the “resequence” operation. Also, a graph 804 plots the production of different materials by an upstream node 302 after the “resequence” operation. Notice that there are far fewer product transitions for the upstream node 302 as shown in the graph 804. This indicates that the “resequence” operation can successfully reduce the total transition costs by identifying a sequence of product batches at the downstream node 302 and implicitly reducing the number of transitions at the upstream node 302.

Although FIG. 7 illustrates one example of search results 700 obtained using a resequence process to change the order of batches of materials in a production schedule and FIG. 8 illustrates one example of results obtained using a resequence process to change the order of batches of materials in a production schedule, various changes may be made to FIGS. 7 and 8. For example, the search results and other results of the resequence process may vary based on a number of factors, such as the specific relaxed optimization schedule being processed.

With respect to the “round to production unit” post-processing operation, the resequence process may reorder the production of various materials, but at this point the merged production batches are not guaranteed to have integer multiples of quantities of specified production units. Stated another way, equipment may be used to produce a specified quantity of a material, and there is no guarantee that the results of the resequence process include an integer multiple of that specified quantity. To address this, the “round to production unit” operation generally operates to round up (if necessary) one or more of the production quantities that are output from the resequence process so that each production quantity is an integer multiple of the associated production unit. Note that the duration of individual batches can be increased here to accommodate for the additional production required.

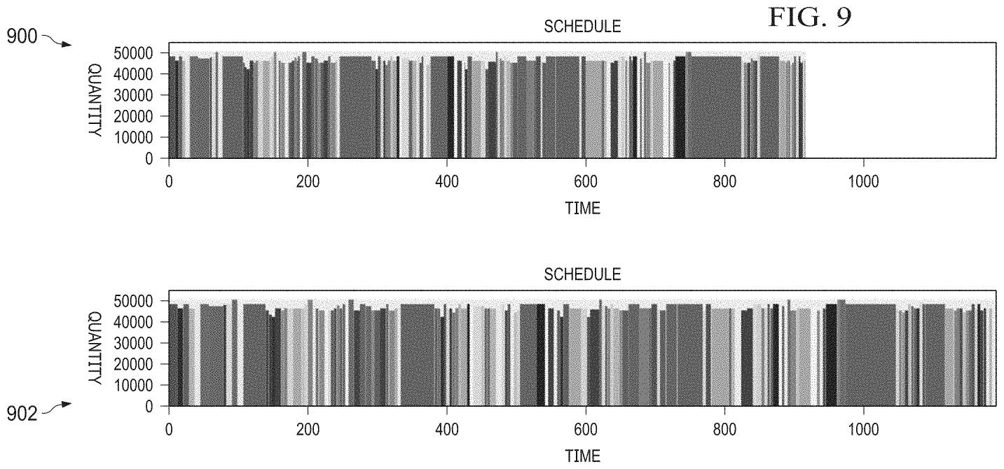

FIG. 9 illustrates example results obtained using a round to production unit process to change the quantities of materials in a production schedule according to this disclosure. As shown in FIG. 9, a graph 900 plots the production of different materials prior to the “round to production unit” operation, and a graph 902 plots the production of different materials after the “round to production unit” operation. As can be seen here, the production of the materials now occurs over a longer period of time, which is due to the fact that the schedule represented by the graph 900 typically includes production of a non-integer multiple of a production unit for at least one material. Since the actual production of the full production unit for the at least one material may take longer, the “round to production unit” operation can produce a production schedule that is longer in duration.

Although FIG. 9 illustrates one example of results obtained using a round to production unit process to change the quantities of materials in a production schedule, various changes may be made to FIG. 9. For example, the results of the round to production unit process may vary based on a number of factors, such as the specific relaxed optimization schedule being processed.

With respect to the “inject time gap” post-processing operation, when a node 302 changes production from a material i to a material j, there is a time gap between when the material i stops being produced and when the material j begins being produced. This time (referred to as the changeover time above) may include two separate periods of time. The first period of time may represent downtime, which refers to time when production stops entirely. The second period of time may represent transition time, which refers to time during which some type of transition material k may be produced. It is possible that the transition material k can be stored in the inventory 306 and used to satisfy external demand. The “inject time gap” operation generally operates to introduce the appropriate time gaps between the transitions for the material batches in the production schedule.

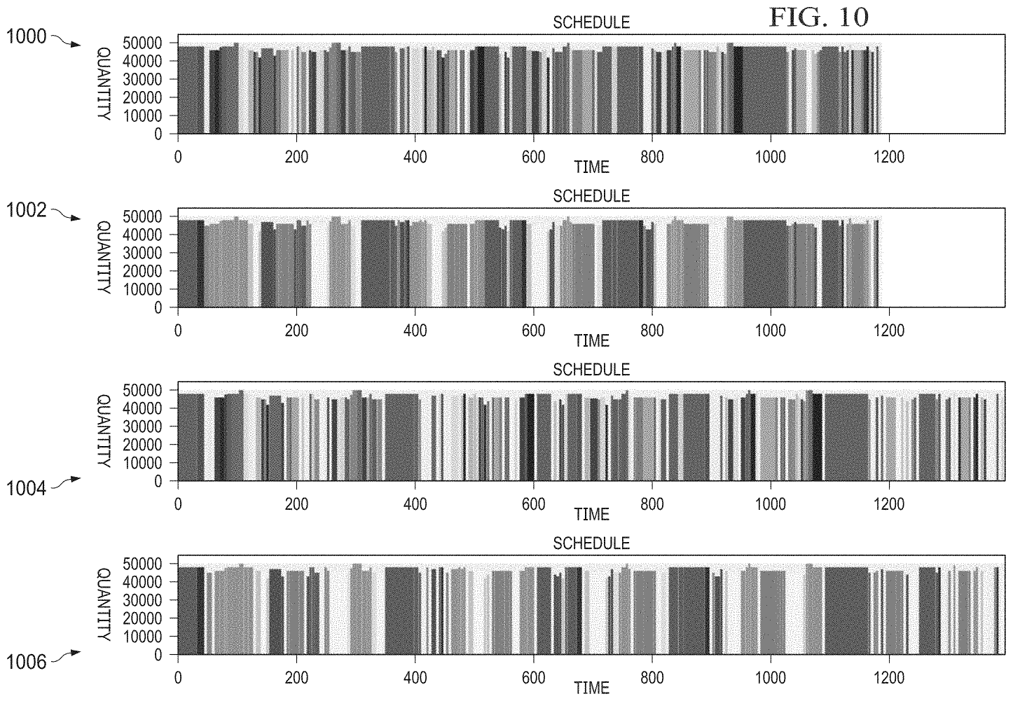

FIG. 10 illustrates example results obtained using an inject time gap process to insert time periods between production of materials in a production schedule according to this disclosure. As shown in FIG. 10, graphs 1000 and 1002 respectively plot the production of different materials by downstream and upstream nodes 302 prior to the “inject time gap” operation, and graphs 1004 and 1006 respectively plot the production of different materials by the downstream and upstream nodes 302 after the “inject time gap” operation.

Although FIG. 10 illustrates one example of results obtained using an inject time gap process to insert time periods between production of materials in a production schedule, various changes may be made to FIG. 10. For example, the results of the inject time gap process may vary based on a number of factors, such as the specific relaxed optimization schedule being processed.

With respect to the “align auxiliary nodes to parent nodes” post-processing operation, an auxiliary node may be defined as a node in a production graph that is not explicitly coupled to any parent node as part of a line (where a line represents a set of coupled nodes that produce one or more materials simultaneously). A node that is part of a line has one parent at most and cannot be part of any other line. The schedule for nodes arranged as a line is simple to modify because the schedule of the most downstream node directly dictates the schedules that the upstream nodes adopt. Schedules for auxiliary nodes are more challenging to modify because they do not have this strict relationship. The “align auxiliary nodes to parent nodes” operation generally operates to align the production of these various nodes.

The “align auxiliary nodes to parent nodes” operation here continues to honor the constraints describing in-flows in Equation (8) and sets of exclusive edges in Equation (24), which may both pertain to auxiliary nodes. This may be accomplished by sequentially checking each production batch for each parent node and aligning the largest possible production batch in an auxiliary node to consume the parent batch as an ingredient. A production batch can consume a parent batch as an ingredient if the alignment of the batches satisfies the in-flow constraint of Equation (8) and the exclusive edge set constraints of Equation (24). This greedy allocation may be repeated until all parent nodes are inspected or there are no remaining batches to allocate in the auxiliary nodes.

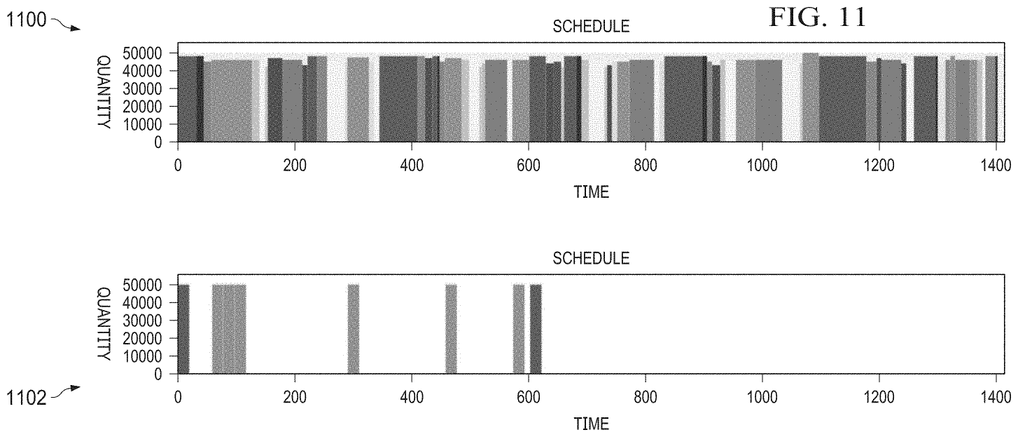

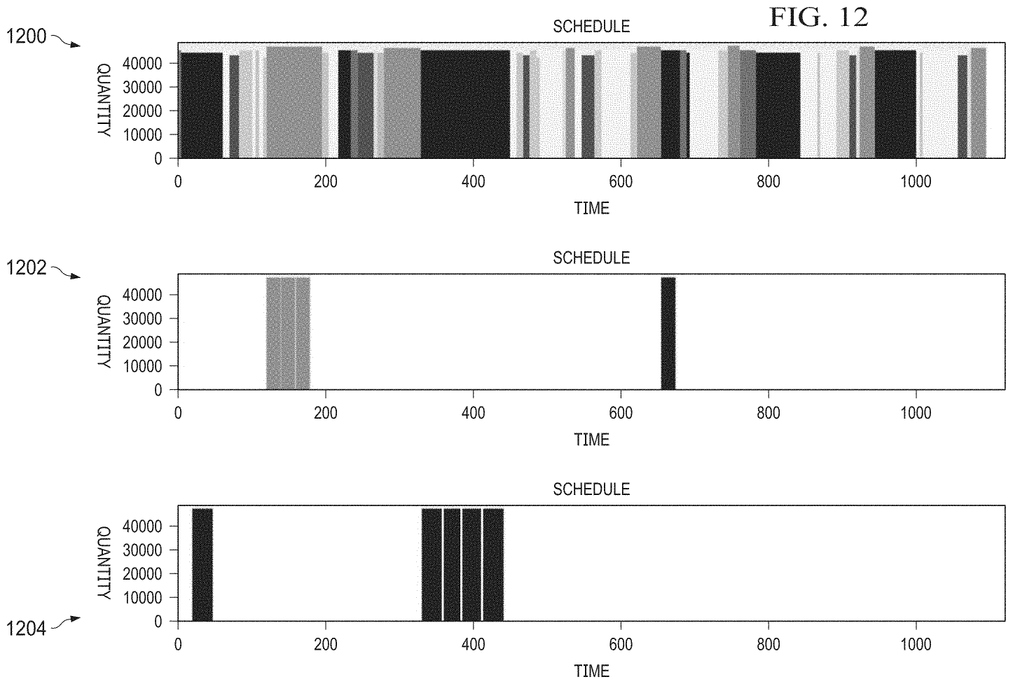

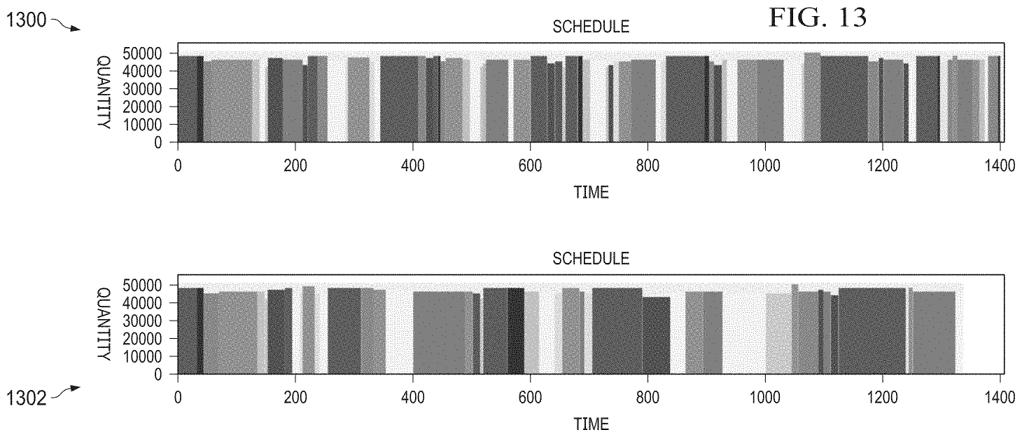

FIGS. 11 and 12 illustrate example results obtained using an align auxiliary nodes to parent nodes process to align production by different nodes according to this disclosure. As shown in FIG. 11, a graph 1100 plots the production of different materials by a first parent node, and a graph 1102 plots the production of one or more materials by an auxiliary node associated with the first parent node. As shown in FIG. 12, a graph 1200 plots the production of different materials by a second parent node, a graph 1202 plots the production of one or more materials by a first auxiliary node associated with the second parent node, and a graph 1204 plots the production of one or more materials by a second auxiliary node associated with the second parent node. FIGS. 11 and 12 indicate that batches of materials for the auxiliary nodes are aligned with their parent nodes and that the exclusivity constraint is satisfied.

Although FIGS. 11 and 12 illustrate examples of results obtained using an align auxiliary nodes to parent nodes process to align production by different nodes, various changes may be made to FIGS. 11 and 12. For example, the results of the align auxiliary nodes to parent nodes process may vary based on a number of factors, such as the specific relaxed optimization schedule being processed.

With respect to the “align auxiliary nodes to inventory” post-processing operation, there may be some instances where one or more production batches at one or more auxiliary nodes receive at least one ingredient stored in an inventory 306. In that case, a similar alignment process referred to as an “align auxiliary nodes to inventory” operation may be performed between the auxiliary node(s) and the inventory 306. In addition to the in-flow and exclusive edge sets constraints, the inventory out-flow constraint of Equation (12) can also be satisfied. Aside from this and the added constraint of not allocating production during periods of time where batches are assigned via the “align auxiliary nodes to parent nodes” operation, the “align auxiliary nodes to inventory” operation can be identical to the “align auxiliary nodes to parent nodes” operation. Ideally, the “align auxiliary nodes to inventory” operation occurs and results in no periods of time during the production schedule in which the inventory out-flow constraint of Equation (12) is violated.

With respect to the “shift and merge” post-processing operation, the post-processing operations described thus far can produce a feasible baseline schedule for which the objective function is not explicitly optimized. To optimize the loss function directly, the “shift and merge” operation can be applied, which generally operates to combine production batches of the same material. More specifically, in the “shift and merge” operation, production batches for the same material may be merged together if the resulting production schedule has a lower total cost, and this can be repeated until a local optima is reached. Note that this problem may have many local optima and is sensitive to two orderings. The first ordering relates to the order of the materials for which the “shift and merge” operation is performed, and the second ordering relates to the order in which candidate batches to merge are selected. Additionally, this problem is NP-hard with a time complexity of m!πᵢ₌₁^{m} n_{b}_{ᵢ}! (where m represents the number of unique materials, and n_{b}_{ᵢ} represents the number of batches for material i).

In some embodiments, to search for the best production schedules across these two orderings, a beam search can be used to sample the search space. This may be equivalent to having a beam width w number of solutions competing with each other until shift and merge converges. An example implementation of such an algorithm, along with its pseudocode, is provided below.

Algorithm 3: Beam Search Shift and Merge

| | Input: production graph G, batch selection function fₛ, batch group function f_{q}, mergeable | | | | | |
|---|---|---|---|---|---|---|
| | | | checking function fₘ, graph evaluate function f_{c}, batch modify function f₊, batch | | | |
| | | | recover function f₋, beam width w, sample rate r | | | |
| | Result: production graph Gₘᵢₙ with the minimum cost | | | | | |
| 1 | compute the cost of the initial production graph c = f_{c}(G) ; | | | | | |
| 2 | define a search state as a tuple of (G, c), graph and associate cost ; | | | | | |
| 3 | initialize max priority queue with length limit of w, and the priority queue is q(w) ; | | | | | |
| 4 | initialize a container v for saving the converged states ; | | | | | |
| 5 | add the initial state into q ; | | | | | |
| 6 | while q is not empty do | | | | | |
| 7 | \| | states to expand is a shallow copy of the current q ; | | | | |
| 8 | \| | for s ∈ states to expand do | | | | |
| 9 | \| | \| | if s.cost > peek(q).cost then | | | |
| 10 | \| | \| | └ | continue | | |
| 11 | \| | \| | cost reduction = 0 ; | | | |
| 12 | \| | \| | all batches can be modified = fₛ(s.graph) ; | | | |
| 13 | \| | \| | batches actually modified = random sample r of all batches ; | | | |
| 14 | \| | \| | groups = f_{g}(batches actually modified); | | | |
| 15 | \| | \| | material order is ordered key of groups ; | | | |
| 16 | \| | \| | shuffle(material order) ; | | | |
| 17 | \| | \| | for m ∈ material order do | | | |
| 18 | \| | \| | \| | for mergeable pair b1, b2 given fₘ(b1,b2) ∈ all pairs of groups[m] do | | |
| 19 | \| | \| | \| | \| | f₊(b1,b2); | |
| 20 | \| | \| | \| | \| | new cost is f_{c}(G); | |
| 21 | \| | \| | \| | \| | if new cost < peek(q).cost then | |
| 22 | \| | \| | \| | \| | \| | new graph = deep copy of G ; |
| 23 | \| | \| | \| | \| | \| | new state = (new graph, new cost) ; |
| 24 | \| | \| | \| | \| | \| | add new state to q ; |
| 25 | \| | \| | \| | \| | └ | cost reduction = max(cost reduction, 0); |

| | | | | | |
|---|---|---|---|---|---|
| 26 | \| | \| | └ | └ | f₋(b1,b2) |

| 27 | \| | \| | if no cost reduction and s still ∈ q then | |
|---|---|---|---|---|
| 28 | \| | \| | \| | remove s from q ; |
| 29 | \| | \| | \| | reduce the max length of q by 1; |
| 30 | └ | └ | └ | add s to v; |

| | |
|---|---|
| 31 | Gₘᵢₙ = min(state ∈ v) with state compared by cost; |
| 32 | return Gₘᵢₙ; |

To sufficiently explore the search space, a large width and a large sample rate may be used during a beam search, but this can increase computation time significantly. To alleviate this issue, in some embodiments, a multi-phase beam search may be utilized. First, a rough beam search with a large width and a small sample rate may be performed to obtain a partially-optimized schedule. Second, the partially-optimized schedule is used as the initial condition for a second beam search with a decreased beam width and a larger sample rate. This procedure may be repeated several times before a final sample rate of one is used to converge to a globally-optimal solution for that particular iteration. This multi-phase approach can significantly reduce the run time of the algorithm. An example implementation of such an algorithm, along with its pseudocode, is provided below.

Algorithm 4: Multi-Phase Beam Search Shift and Merge

| | Input: base beam search function f, arguments for x other than the | |
|---|---|---|
| | | width and the sample rate, list of tuples for beam |
| | | width and sample rate used in each phase P |
| | Result: production graph Gₘᵢₙ with the minimum cost | |
| 1 | Gₘᵢₙ = x.graph ; | |
| 2 | for p ∈ P do | |
| 3 | └ | Gₘᵢₙ = f(x,p); |

| | |
|---|---|
| 4 | return Gₘᵢₙ; |

Although each iteration of the shift and merge may be computationally cheap, realigning the schedules of auxiliary nodes at each step to ensure a fully-feasible schedule may be computationally expensive. To reduce the computation time, in some cases, the shift and merge may be applied without aligning the auxiliary nodes at each step. Although each step may result in an infeasible production schedule, it can be assumed that the majority of the material productions and schedule costs are driven by nodes belonging to production lines. As a result, the infeasible production schedules resulting from each iteration of the shift and merge may be good approximations of a true feasible production schedule. Auxiliary alignment may therefore be performed at the end of all shift and merge iterations to yield a final feasible and locally-optimal production schedule. An additional technique to improve performance is to allow the shift and merge to occur across downstream nodes that belong to separate production lines. Since it is possible for some materials to be produced by multiple downstream nodes, allowing the shift and merge operation to be performed across multiple production lines can reduce the number of transitions by letting each node specialize in a subset of materials.

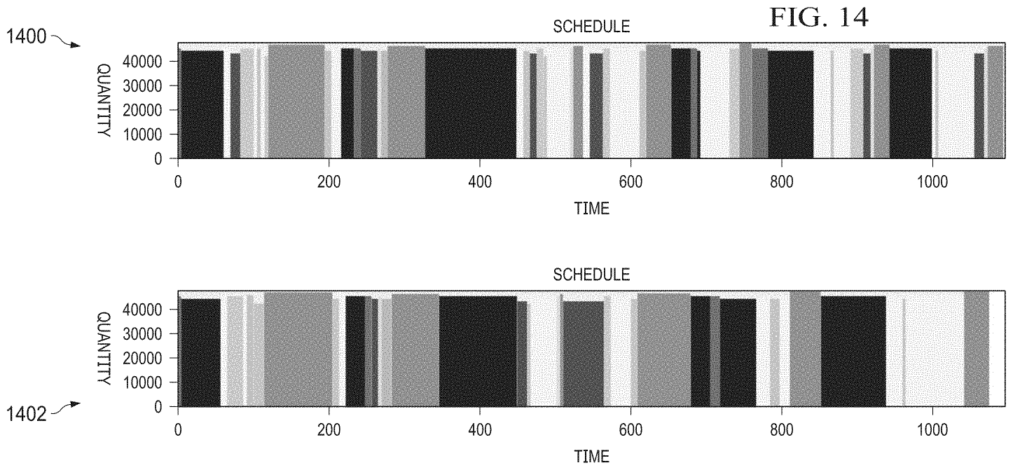

FIGS. 13 and 14 illustrate example results obtained using a shift and merge process to combine production of common materials in a production schedule according to this disclosure. As shown in FIG. 13, a graph 1300 plots the production of different materials by a first node prior to the “shift and merge” operation, and a graph 1302 plots the production of the materials by the first node after the “shift and merge” operation (which may be implemented using a multi-phase beam search shift and merge). As shown in FIG. 14, a graph 1400 plots the production of different materials by a second node prior to the “shift and merge” operation, and a graph 1402 plots the production of the materials by the second node after the “shift and merge” operation (which again may be implemented using a multi-phase beam search shift and merge). Note that larger batches may be formed to reduce the transition costs. Also note that, at the same time, batches with originally-larger sizes may remain at their initial locations to avoid large serviceability costs. Additionally, note that the overall duration of a production schedule may be shorter, which may be due (among other things) to the reduced number of transitions and the associated reduced changeover times.

Although FIGS. 13 and 14 illustrate examples of results obtained using a shift and merge process to combine production of common materials in a production schedule, various changes may be made to FIGS. 13 and 14. For example, the results of the shift and merge may vary based on a number of factors, such as the specific relaxed optimization schedule being processed.

With respect to the “inject transition material” post-processing operation, the production of any transition materials during transition times can be reflected correctly in the production schedule. In some cases, this may occur as follows. Batches of transition materials can be injected into the production schedule during the appropriate transition times. Notice that this introduces excess production of the transition material. To handle this, production batches of the transition material (which are not the result of product transitions) can be removed from the production schedule, as long as doing so does not cause the inventory 306 to go negative. Removing a production batch from the production schedule results in the batches that were before and after the removed batch now being adjacent to one another, which may require the introduction of a changeover time and production of a transition material if applicable. Therefore, the process of adding the transition materials and removing excess batches can be repeated until no excess batches exist in the production schedule.

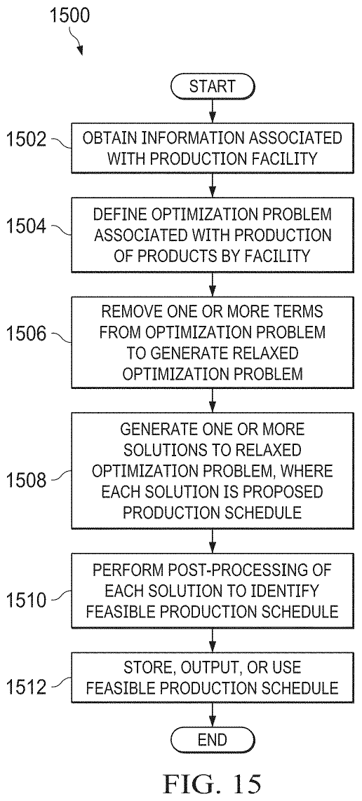

FIG. 15 illustrates an example method 1500 for constrained optimization and post-processing heuristics for optimal production scheduling for process manufacturing according to this disclosure. For ease of explanation, the method 1500 of FIG. 15 is described as being performed using the application server 106 of FIG. 1, which may be implemented using one or more instances of the device 200 of FIG. 2. However, the method 1500 of FIG. 15 may be performed using any suitable device(s) in any suitable system(s).

As shown in FIG. 15, information associated with a production facility is obtained at step 1502. This may include, for example, the processing device 202 of the application server 106 obtaining information identifying multiple processing units in a facility, such as multiple pieces of equipment represented by multiple nodes 302 of a graph representation. This may also include the processing device 202 of the application server 106 obtaining information identifying multiple interconnections between the processing units, such as multiple flows 304 of materials to, from, and between the nodes 302 of the graph representation. This may further include the processing device 202 of the application server 106 obtaining information identifying constraints associated with the processing units and the interconnections, such as one or more constraints on the nodes 302 and one or more constraints on the flows 304. This information may be obtained from any suitable source(s), such as from the database 110 or from one or more user devices 102a-102d.

An optimization problem associated with production of multiple products by the processing units in the facility is defined at step 1504. This may include, for example, the processing device 202 of the application server 106 generating an optimization problem having the form shown in Equations (29)-(30) above. Note that the application server 106 may also receive the optimization problem after formulation by another device or by one or more users. In general, the optimization problem may be identified in any suitable manner. The optimization problem is associated with a cost function, which may be used to capture various information about costs associated with the optimization problem (like production transition costs, inventory holding costs, and serviceability costs).

One or more terms are removed from the optimization problem to generate a relaxed optimization problem at step 1506. This may include, for example, the processing device 202 of the application server 106 removing one or more terms from the cost function associated with transition costs and/or removing one or more terms from the cost function associated with changeover times, where each transition cost and/or changeover time is associated with a switch from production of one product to production of another product. Note that the application server 106 may also receive the relaxed optimization problem with the one or more terms removed from another device or from one or more users. In general, the relaxed optimization problem may be identified in any suitable manner.

One or more solutions to the relaxed optimization problem are identified, where each solution represents a proposed production schedule for the facility, at step 1508. This may include, for example, the processing device 202 of the application server 106 performing constrained optimization of the relaxed optimization problem to identify one or more solutions to the relaxed optimization problem. This allows at least one approximate optimal solution for the full optimization problem to be obtained by solving the relaxed formulation of the optimization problem. Note that various approaches for performing constrained optimization are known in the art, and other approaches are sure to be developed in the future. Any suitable technique for performing constrained optimization of an optimization problem may be used here, such as techniques for performing nonlinear constrained optimization.

Post-processing of the one or more solutions is performed to identify a feasible production schedule for the processing units in the facility at step 1510. This may include, for example, the processing device 202 of the application server 106 performing one or more of the post-processing functions described above. In some embodiments, these post-processing functions may include one or more of the “chunk and merge” operation, the “resequence” operation, the “round to production unit” operation, the “inject time gap” operation, the “align auxiliary nodes to parent nodes” operation, the “align auxiliary nodes to inventory” operation, the “shift and merge” operation, and the “inject transition material” operation. Note that one, some, or all of these post-processing functions may be performed depending on the implementation.

The feasible production schedule can be stored, output, or used in some manner at step 1512. This may include, for example, the processing device 202 of the application server 106 outputting the feasible production schedule to one or more users (such as via a graphical user interface of one or more user devices 102a-102d) for approval, rejection, or modification. This may also or alternatively include the processing device 202 of the application server 106 using the feasible production schedule to control the equipment in the facility in order to implement the feasible production schedule, which may occur with or without human approval, oversight, or intervention. In general, the feasible production schedule may be used in any suitable manner, and all manners of use are within the scope of this disclosure.

Although FIG. 15 illustrates one example of a method 1500 for constrained optimization and post-processing heuristics for optimal production scheduling for process manufacturing, various changes may be made to FIG. 15. For example, while shown as a series of steps, various steps in FIG. 15 may overlap, occur in parallel, occur in a different order, or occur any number of times (including possibly zero times).

The following describes example embodiments of this disclosure that implement constrained optimization and post-processing heuristics for optimal production scheduling for process manufacturing. However, other embodiments may be used in accordance with the teachings of this disclosure.

In a first embodiment, a method includes obtaining a solution representing a proposed production schedule associated with multiple processing units in a facility, where the multiple processing units are capable of producing different products. The method also includes performing post-processing of the solution to identify a final production schedule for the processing units in the facility. The post-processing of the solution includes multiple operations each configured to modify the proposed production schedule so that the final production schedule is feasible given constraints associated with the processing units in the facility.

In a second embodiment, an apparatus includes at least one processing device configured to obtain a solution representing a proposed production schedule associated with multiple processing units in a facility, where the multiple processing units are capable of producing different products. The at least one processing device is also configured to perform post-processing of the solution to identify a final production schedule for the processing units in the facility. The post-processing of the solution includes multiple operations each configured to modify the proposed production schedule so that the final production schedule is feasible given constraints associated with the processing units in the facility.

In a third embodiment, a non-transitory computer readable medium stores computer readable program code that when executed causes one or more processors to obtain a solution representing a proposed production schedule associated with multiple processing units in a facility, where the multiple processing units are capable of producing different products. The medium also stores computer readable program code that when executed causes the one or more processors to perform post-processing of the solution to identify a final production schedule for the processing units in the facility. The post-processing of the solution includes multiple operations each configured to modify the proposed production schedule so that the final production schedule is feasible given constraints associated with the processing units in the facility.

Any single one or any suitable combination of the following features may be used with the first, second, or third embodiment. The post-processing of the solution may include at least one of: discretizing the proposed production schedule into chunks and merging batches of common products for each chunk, ordering production batches to minimize transition costs within each chunk, rounding production batches in the proposed production schedule to integer multiples of a production unit, and introducing downtimes and transition times into the proposed production schedule. The post-processing of the solution may include at least one of: ensuring that production batches on auxiliary processing units align to production batches of their parent processing units and ensuring that the production batches on the auxiliary processing units align to raw materials available in inventory. The post-processing of the solution may include searching for a locally-optimal schedule by merging of production batches in the proposed production schedule. The proposed production schedule may be infeasible based on one or more of the constraints associated with the processing units in the facility, and the post-processing of the solution may be performed to correct one or more infeasibilities of the proposed production schedule to ensure that the final production schedule is feasible given the constraints associated with the processing units in the facility. The proposed production schedule may be infeasible based on generation of the proposed production schedule using an optimization problem formulated without honoring one or more of the constraints, and the post-processing of the solution may be performed to cause the final production schedule to honor the one or more of the constraints not honored by the optimization problem. The one or more of the constraints not honored by the optimization problem may include at least one of: (i) for a production batch defined as a continuous duration producing a single material, a total quantity produced in the production batch is an integer multiple of a production unit; (ii) consecutive production batches of different materials have a non-negative downtime defined as a period of time where material is not being produced; and (iii) consecutive production batches of different materials have a non-negative transition time defined as a period of time where a transition material is produced. During the post-processing of the solution, a recursive doubly-linked list data structure may be used to represent batches of materials to be produced by the processing units.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrases “at least one of” and “one or more of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining a solution representing a proposed production schedule associated with multiple processing units in a facility, the multiple processing units capable of producing different products; and
performing post-processing of the solution to identify a final production schedule for the processing units in the facility, wherein the post-processing of the solution comprises multiple operations each configured to modify the proposed production schedule so that the final production schedule is feasible given constraints associated with the processing units in the facility.

2. The method of claim 1, wherein performing the post-processing of the solution comprises at least one of:
discretizing the proposed production schedule into chunks and merging batches of common products for each chunk;
ordering production batches to minimize transition costs within each chunk;
rounding production batches in the proposed production schedule to integer multiples of a production unit; and
introducing downtimes and transition times into the proposed production schedule.

3. The method of claim 2, wherein performing the post-processing of the solution further comprises at least one of:
ensuring that production batches on auxiliary processing units align to production batches of their parent processing units; and
ensuring that the production batches on the auxiliary processing units align to raw materials available in inventory.

4. The method of claim 3, wherein performing the post-processing of the solution further comprises:
searching for a locally-optimal schedule by merging of production batches in the proposed production schedule.

5. The method of claim 1, wherein:
the proposed production schedule is infeasible based on one or more of the constraints associated with the processing units in the facility; and
performing the post-processing of the solution corrects one or more infeasibilities of the proposed production schedule to ensure that the final production schedule is feasible given the constraints associated with the processing units in the facility.

6. The method of claim 5, wherein:
the proposed production schedule is infeasible based on generation of the proposed production schedule using an optimization problem formulated without honoring one or more of the constraints; and
performing the post-processing of the solution causes the final production schedule to honor the one or more of the constraints not honored by the optimization problem.

7. The method of claim 6, wherein the one or more of the constraints not honored by the optimization problem comprise at least one of:
for a production batch defined as a continuous duration producing a single material, a total quantity produced in the production batch is an integer multiple of a production unit;
consecutive production batches of different materials have a non-negative downtime defined as a period of time where material is not being produced; and
consecutive production batches of different materials have a non-negative transition time defined as a period of time where a transition material is produced.

8. The method of claim 1, wherein, during the post-processing of the solution, a recursive doubly-linked list data structure is used to represent batches of materials to be produced by the processing units.

9. An apparatus comprising:
at least one processing device configured to:
obtain a solution representing a proposed production schedule associated with multiple processing units in a facility, the multiple processing units capable of producing different products; and
perform post-processing of the solution to identify a final production schedule for the processing units in the facility, wherein the post-processing of the solution comprises multiple operations each configured to modify the proposed production schedule so that the final production schedule is feasible given constraints associated with the processing units in the facility.

10. The apparatus of claim 9, wherein, to perform the post-processing of the solution, the at least one processing device is configured to at least one of:
discretize the proposed production schedule into chunks and merge batches of common products for each chunk;
order production batches to minimize transition costs within each chunk;
round production batches in the proposed production schedule to integer multiples of a production unit; and
introduce downtimes and transition times into the proposed production schedule.

11. The apparatus of claim 10, wherein, to perform the post-processing of the solution, the at least one processing device is further configured to at least one of:
ensure that production batches on auxiliary processing units align to production batches of their parent processing units; and
ensure that the production batches on the auxiliary processing units align to raw materials available in inventory.

12. The apparatus of claim 11, wherein, to perform the post-processing of the solution, the at least one processing device is further configured to:
search for a locally-optimal schedule by merging of production batches in the proposed production schedule.

13. The apparatus of claim 9, wherein:
the proposed production schedule is infeasible based on one or more of the constraints associated with the processing units in the facility; and
the at least one processing device is configured to perform the post-processing of the solution to correct one or more infeasibilities of the proposed production schedule and ensure that the final production schedule is feasible given the constraints associated with the processing units in the facility.

14. The apparatus of claim 13, wherein:
the proposed production schedule is infeasible based on generation of the proposed production schedule using an optimization problem formulated without honoring one or more of the constraints; and
the at least one processing device is configured to perform the post-processing of the solution to cause the final production schedule to honor the one or more of the constraints not honored by the optimization problem.

15. The apparatus of claim 14, wherein the one or more of the constraints not honored by the optimization problem comprise at least one of:
for a production batch defined as a continuous duration producing a single material, a total quantity produced in the production batch is an integer multiple of a production unit;
consecutive production batches of different materials have a non-negative downtime defined as a period of time where material is not being produced; and
consecutive production batches of different materials have a non-negative transition time defined as a period of time where a transition material is produced.

16. The apparatus of claim 9, wherein, during the post-processing of the solution, the at least one processing device is configured to use a recursive doubly-linked list data structure to represent batches of materials to be produced by the processing units.

17. A non-transitory computer readable medium storing computer readable program code that when executed causes one or more processors to:
obtain a solution representing a proposed production schedule associated with multiple processing units in a facility, the multiple processing units capable of producing different products; and
perform post-processing of the solution to identify a final production schedule for the processing units in the facility, wherein the post-processing of the solution comprises multiple operations each configured to modify the proposed production schedule so that the final production schedule is feasible given constraints associated with the processing units in the facility.

18. The non-transitory computer readable medium of claim 17, wherein the computer readable program code that when executed causes the one or more processors to perform the post-processing of the solution comprises:
computer readable program code that when executed causes the one or more processors to at least one of:
discretize the proposed production schedule into chunks and merge batches of common products for each chunk;
order production batches to minimize transition costs within each chunk;
round production batches in the proposed production schedule to integer multiples of a production unit; and
introduce downtimes and transition times into the proposed production schedule.

19. The non-transitory computer readable medium of claim 18, wherein the computer readable program code that when executed causes the one or more processors to perform the post-processing of the solution further comprises:
computer readable program code that when executed causes the one or more processors to at least one of:
ensure that production batches on auxiliary processing units align to production batches of their parent processing units; and
ensure that the production batches on the auxiliary processing units align to raw materials available in inventory.

20. The non-transitory computer readable medium of claim 19, wherein the computer readable program code that when executed causes the one or more processors to perform the post-processing of the solution further comprises:
computer readable program code that when executed causes the one or more processors to search for a locally-optimal schedule by merging of production batches in the proposed production schedule.

21. The non-transitory computer readable medium of claim 17, wherein:
the proposed production schedule is infeasible based on one or more of the constraints associated with the processing units in the facility; and
the computer readable program code when executed causes the one or more processors to perform the post-processing of the solution to correct one or more infeasibilities of the proposed production schedule and ensure that the final production schedule is feasible given the constraints associated with the processing units in the facility.

22. The non-transitory computer readable medium of claim 21, wherein:
the proposed production schedule is infeasible based on generation of the proposed production schedule using an optimization problem formulated without honoring one or more of the constraints; and
the computer readable program code when executed causes the one or more processors to perform the post-processing of the solution to cause the final production schedule to honor the one or more of the constraints not honored by the optimization problem.

23. The non-transitory computer readable medium of claim 22, wherein the one or more of the constraints not honored by the optimization problem comprise at least one of:
for a production batch defined as a continuous duration producing a single material, a total quantity produced in the production batch is an integer multiple of a production unit;
consecutive production batches of different materials have a non-negative downtime defined as a period of time where material is not being produced; and
consecutive production batches of different materials have a non-negative transition time defined as a period of time where a transition material is produced.

24. The non-transitory computer readable medium of claim 17, wherein the computer readable program code when executed causes the one or more processors, during the post-processing of the solution, to use a recursive doubly-linked list data structure to represent batches of materials to be produced by the processing units.
